(19) United States
(12) Patent Application Publication
(10) Pub. No.: US 2020/0368654 A1
(43) Pub. Date: Nov. 26, 2020

(54) FILTER MEDIA COMPRISING ELASTOMERIC FIBERS

(71) Applicant: Hollingsworth & Vose Company, East Walpole, MA (US)

(72) Inventors: Keith Higginson, Holden, MA (US); Sneha Swaminathan, Merrimack, NH (US)

(73) Assignee: Hollingsworth & Vose Company, East Walpole, MA (US)

(21) Appl. No.: 16/421,817

(22) Filed: May 24, 2019

(51) Int. Cl. B01D 39/16; B32B 5/02; B32B 5/26; B32B 7/12

(52) U.S. Cl. CPC B01D 39/163; B32B 5/022; B32B 5/26; B32B 7/12; B01D 2239/0618; B01D 2239/0631; B32B 2307/726; B01D 2239/0681; B01D 2239/1258; B01D 2239/1233; B32B 2250/20; B32B 2262/0261; B32B 2307/724; B01D 2239/0622

(57) ABSTRACT

Filter media comprising one or more layers comprising nanofibers are generally described. In some embodiments, a filter media comprises a layer comprising nanofibers. The nanofibers may comprise an elastomer, a multiblock copolymer, and/or a multiblock copolymer that is an elastomer.

### FIELD

The present invention relates generally to filter media, and, more particularly, to filter media including elastomeric nanofibers.

### BACKGROUND

Filter media may be used to remove one or more contaminants from a fluid. Some filter media include layers comprising nanofibers that increase the filtration performance of the filter media. However, these layers comprising nanofibers may be made up of nanofibers that are undesirably stiff and/or brittle, which may disadvantageously decrease the toughness and/or elastic extensibility of the filter media. Accordingly, improved filter media and associated compositions and methods are needed.

### SUMMARY

Filter media, related components, and related methods are generally described.

In some embodiments, a filter media is provided. The filter media comprises a first layer comprising nanofibers and a second layer. The nanofibers comprise a multiblock copolymer comprising one or more poly(amide) blocks, and the one or more poly(amide) blocks make up greater than or equal to 20 mol % and less than 100 mol % the multiblock copolymer.

In some embodiments, a filter media is provided. The filter media comprises a first layer comprising nanofibers and a second layer. The nanofibers comprise an elastomer and are at least partially fibrillated.

In some embodiments, a filter media is provided. The filter media comprises a first layer comprising nanofibers and a second layer. The nanofibers comprise an elastomer. The first layer has an initial water contact angle of greater than or equal to 70°.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows one non-limiting embodiment of a filter media comprising a layer comprising nanofibers, in accordance with some embodiments;

FIG. 2 shows one non-limiting embodiment of a multilayer filter media, in accordance with some embodiments;

FIG. 3A shows one non-limiting embodiment of a diblock copolymer comprising A and B blocks that are not microphase separated, in accordance with some embodiments;

FIG. 3B shows one non-limiting embodiment of a diblock copolymer comprising A and B blocks that are microphase separated, in accordance with some embodiments;

FIG. 4A shows one example of a nanoparticle located in an interior of a nanofiber, in accordance with some embodiments;

FIGS. 4B-4C show different examples of nanoparticles located at the surfaces of nanofibers, in accordance with some embodiments;

FIGS. 4D-4E show different examples of nanoparticles not embedded in nanofibers;

FIGS. 5A-5F show non-limiting examples of designs suitable for fuel filters, in accordance with some embodiments;

FIGS. 6A-6D show non-limiting examples of designs suitable for hydraulic fluid filters, in accordance with some embodiments;

FIGS. 7A-7B show non-limiting examples of designs suitable for HEPA filters, in accordance with some embodiments;

FIG. 8 shows one non-limiting example of a design suitable for gas turbines and/or dust collectors, in accordance with some embodiments;

FIG. 9 shows distributions of fiber width for some layers comprising nanofibers, in accordance with some embodiments; and

FIGS. 10A-10C show SEM images of layers comprising nanofibers, in accordance with some embodiments.

### DETAILED DESCRIPTION

Articles and methods involving filter media are generally provided. In some embodiments, a filter media comprises a layer comprising nanofibers that comprise a material having one or more advantageous properties.

One example of a type of material having one or more advantageous properties is an elastomer. Without wishing to be bound by any theory, it is believed that elastomers may be capable of undergoing high levels of elastically recoverable elongation, may have tensile strengths suitable for use in filter media, and/or may be less susceptible to brittle failure than other types of materials. It is also believed that nanofibers comprising such elastomers may retain many of these beneficial properties and may cause the layer(s) in which they are positioned to exhibit many of these beneficial properties. Accordingly, it is believed that the incorporation of elastomers into nanofibers in one or more layers of a filter media may enhance the mechanical robustness of the filter media and/or reduce the tendency of the filter media to undergo catastrophic failure. Filter media having these enhanced mechanical properties may be desirable for use in applications where other filter media fail mechanically at an unacceptably high rate, such as high pressure filtration applications.

Another example of a type of material having advantageous properties is a copolymer, such as a multiblock copolymer, comprising a combination of polymerized monomers that are together beneficial and/or that provide complementary benefits to the nanofibers. By way of example, a copolymer may comprise repeat units that enhance its hydrophilicity. Incorporating such a copolymer into nanofibers in a layer of a filter media may enhance the nanofibers' hydrophilicity, which may in turn enhance the hydrophilicity of the layer in which the nanofibers are positioned and the hydrophilicity of the filter media. As another example, one type of copolymer that may be desirable for use in nanofibers is a copolymer comprising a combination of repeat units that causes the copolymer to be an elastomer. Such combinations of repeat units are described in further detail below.

It should be noted that while copolymers that are elastomers may be highly beneficial in some embodiments, elastomers other than copolymers are also contemplated and copolymers other than elastomers are contemplated. Accordingly, references to copolymers should be understood to refer to both copolymers that are elastomers and copolymers that are not elastomers unless otherwise specified. Similarly, references to elastomers should be understood to refer to both elastomers that are copolymers and elastomers that are not copolymers unless otherwise specified.

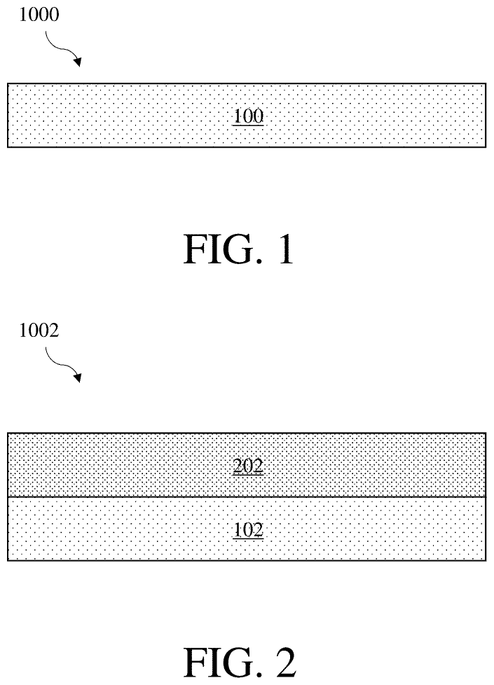

As described above, some embodiments relate to a filter media comprising a layer comprising nanofibers. The nanofibers may comprise an elastomer and/or may comprise a copolymer. FIG. 1 shows one non-limiting embodiment of a filter media comprising a layer comprising nanofibers, in which a filter media 1000 comprises a layer 100 comprising nanofibers. In some embodiments, a filter media may comprise two or more layers. In other words, it may be a multilayer filter media. In some embodiments, at least one of the two or more layers may comprise nanofibers (not shown). FIG. 2 shows one non-limiting embodiment of a multilayer filter media 1002 comprising a layer 102 comprising nanofibers (not shown) and a supplemental layer 202. In some embodiments, a filter media comprises one or more layers comprising nanofibers and one or more supplemental layers. For instance, the filter media may comprise at least three layers, at least four layers, at least five layers, or six or more layers.

A variety of suitable supplemental layers may be employed in conjunction with at least one layer comprising nanofibers to form a multilayer filter media. For instance, a filter media may comprise a layer comprising nanofibers and one or more of the following types of layers: prefilter layers, scrims, meltblown layers, wetlaid layers, airlaid layers, and spunbond layers, and carded layers. A layer comprising nanofibers may be deposited onto a backer layer, and then one or more further supplemental layers may be laminated thereon (e.g., facing the backer layer, facing the layer comprising the nanofibers). Without wishing to be bound by any particular theory, it is believed that meltblown layers may enhance the capacity of the filter media and/or may perform intermediate stage filtration, backer layers may enhance the strength and/or pleatability of the filter media, scrims may protect the filter media, and prefilter layers may enhance the capacity of the filter media and/or protect the filter media. In some embodiments, a combination of layers is selected such that a supplemental layer that is a compatibilizing layer is positioned between two layers that are relatively incompatible with each other. For instance, a scrim that is compatible with both a layer comprising nanofibers and a prefilter (such as a synthetic prefilter) may be positioned therebetween to enhance the compatibility of the layer comprising nanofibers with the prefilter. In some embodiments, an adhesive may be positioned between two layers to enhance their compatibility.

The filter media described herein may have a variety of suitable arrangements of layers. In some embodiments, a filter media comprises a layer comprising nanofibers as one of its outermost layers. In some embodiments, a filter media comprises a layer comprising nanofibers that is an interior layer (i.e., a layer that is not an outermost layer). Filter media described herein that are incorporated into filter elements may be positioned such that a layer comprising nanofibers is an upstream-most layer, a downstream-most layer, and/or an interior layer. When a layer comprising nanofibers is an upstream-most layer, it may be particularly tough and/or abrasion resistant (e.g., as evidenced by stable physical properties and/or filtration performance over relatively long periods of time and/or under relatively high pressures). Further information regarding suitable features for layers comprising nanofibers and for supplemental layers is provided below.

A filter media comprising two or more layers may display a stepwise change in one or more properties at the interfaces between the layers. One or more properties may change monotonically (e.g., increase monotonically decrease monotonically) across the filter media and/or one or more properties may change in a manner other than monotonically across the filter media. In some embodiments, air permeability, mean flow pore size, and/or penetration may decrease monotonically across the filter media (e.g., from an upstream surface to a downstream surface) and/or decrease from an upstream surface of the filter media to a layer therein comprising nanofibers. In some embodiments, a layer other than an outermost layer may have lower values of air permeability, mean flow pore size, and/or penetration than the other layers in the filter media.

As described above, some filter media include a layer comprising nanofibers. The layer comprising nanofibers may serve as the efficiency layer for the filter media. In other words, it may contribute appreciably to the filtration performance of the filter media.

As also described above, some filter media described herein comprise two or more layers comprising nanofibers. It should be understood that any individual layer comprising nanofibers may independently have some or all of the properties described below with respect to layers comprising nanofibers. It should also be understood that a filter media may comprise two layers comprising nanofibers that are identical and/or may comprise two or more layers comprising nanofibers that differ in one or more ways.

When present, a layer comprising nanofibers typically takes the form of a non-woven fiber web comprising a plurality of nanofibers. In some embodiments, the layer comprising nanofibers takes the form of an electrospun non-woven fiber web.

In some embodiments, the nanofibers comprise an elastomer. As used herein, an elastomer is a material that is capable of undergoing an elastically recoverable elongation of greater than or equal to 50% at 25° C. The elastomer may be capable of undergoing a relatively large elastically recoverable elongation when in bulk form and/or when in nanofiber form. For instance, in some embodiments, the elastomer is capable of undergoing an elastically recoverable elongation of greater than or equal to 50%, greater than or equal to 75%, greater than or equal to 100%, greater than or equal to 125%, greater than or equal to 150%, greater than or equal to 175%, or greater than or equal to 200% at 25° C. In some embodiments, the elastomer is capable of undergoing an elastically recoverable elongation of less than or equal to 300%, less than or equal to 200%, less than or equal to 175%, less than or equal to 150%, less than or equal to 125%, less than or equal to 100%, or less than or equal to 75% at 25° C. Combinations of the above-referenced ranges are also possible (e.g., greater than or equal to 50% and less than or equal to 300%, or greater than or equal to 50% and less than or equal to 200%). Other ranges are also possible. The elongation that the elastomer is capable of undergoing in bulk form may be determined in accordance with ISO 527-1 (2012).

It should be understood that when a layer comprises nanofibers comprising two or more elastomers, each elastomer may independently be capable of undergoing an elastically recoverable elongation in one or more of the ranges described above. Similarly, it should be understood that when two or more layers comprise nanofibers comprising elastomer(s), the elastically recoverable deformation that the elastomer(s) in each layer may be capable of undergoing may independently fall within one or more of the ranges described above.

When present in nanofibers (e.g., nanofibers positioned in a layer comprising nanofibers), an elastomer may comprise a polymer that is above its glass transition temperature that is crosslinked together by crosslinks (e.g., chemical crosslinks, physical crosslinks). Without wishing to be bound by any particular theory, it is believed that the combination of these two features may result in desirable elastomeric behavior (e.g., enhanced elastically recoverable elongation) for the reasons that follow. Upon application of a force to such elastomers, it is believed that the polymer that is above its glass transition temperature initially readily elongates to accommodate the applied force. After the polymer that is above its glass transition temperature has elongated to its maximum possible extension, it is believed that the crosslinks prevent further elongation of the elastomer as a whole unless sufficient force is applied to sever the covalent bonds along the polymer backbone and/or to sever the crosslinks. If such force is not applied, it is believed that removal of the original applied force will cause the elastomer to recover its initial shape. It is believed that this recovery occurs due to entropic forces which favor a random coil structure for the polymer that is above its glass transition temperature in comparison to an extended structure. If the polymer that is above its glass transition temperature is sufficiently mobile, it may respond rapidly to the application and/or removal of an applied force in a manner that allows for the above-described elastically recoverable elongation. If the length of the polymer between the crosslinks is sufficiently large, the elastically recoverable deformation of the elastomer as a whole may be appreciable.

Some elastomers described herein comprise crosslinks that may be broken and reformed without breaking or forming covalent bonds and some elastomers described herein comprise crosslinks that are permanently formed and may only be broken by breaking covalent bonds. Some suitable elastomers that lack crosslinks that are permanently formed may be capable of being reprocessed one or more times to form a changed macroscopic morphology without appreciably affecting the elastomeric behavior thereof. This may be accomplished by heating the elastomer to break the crosslinks, forming the elastomer into the changed macroscopic morphology, and then cooling the elastomer in the new macroscopic morphology to form new crosslinks. Elastomers capable of undergoing this process are also known as thermoplastic elastomers.

In some embodiments, an elastomer comprises crosslinks that take the form of microphase separated domains formed by microphase separation of a copolymer. These crosslinks may be broken and reformed without breaking or forming covalent bonds. The copolymer may comprise two or more types of repeat units, and one of these types of repeat units may microphase separate from the other type(s) of repeat units to form domains with sizes on the order of nanometers to hundreds of nanometers. Without wishing to be bound by any particular theory, it is believed that deformation of the copolymer to a point requiring deformation and/or breaking apart of these microphase separated domains is thermodynamically disfavored. Accordingly, it is believed that other portions of the copolymer chemically linked to these microdomains are crosslinked by them. In some embodiments, the microphase separated domains may be crystalline, semicrystalline, and/or glassy, which it is believed may enhance the strength of the crosslinks.

In some embodiments, an elastomer comprises crosslinks that take the form of chemical structures with a low molecular weight that covalently bond together two or more polymer chains. These crosslinks are typically, but not always, permanently formed. Such crosslinks may be formed by the reaction of one or more small molecule crosslinkers with a polymer and/or a prepolymer. The ultimately formed crosslink may be the portion of the reaction product of the small molecule crosslinker(s) with the polymers and/or prepolymers that chemically bonds together the polymers and/or prepolymers. For instance, in some embodiments, a crosslink takes the form of a sulfur chain that bonds polymers together (e.g., in the case of vulcanized rubber). As further examples, a crosslink may take the form of a short organic chain or other low molecular weight organic functional group linking together two or more polymers (e.g., an aromatic group to which two or more polymers are bonded).

A third suitable type of crosslink that may be present in some of the elastomers described herein is a crosslink that arises from the inherent chemical structure of a polymer. For instance, step growth polymerization of a prepolymer with three or more reactive functional groups or chain growth polymerization of a prepolymer with two or more reactive functional groups may result in the formation of such an elastomer. Examples of this type of elastomer include polymers formed from the polymerization of diene repeat units (e.g., natural rubber, butadiene), polymers formed from reactions of polyols (e.g., to form poly(urethane)s, via esterification reactions), polymers formed from reactions of polyamines (e.g., to form poly(amides)), and polymers formed from the reactions of formaldehyde-type crosslinkers (e.g., melamine-formaldehyde, urea-formaldehyde, and/or phenol-formaldehyde; with amine functional groups and/or alcohol functional groups).

As described above and when present, nanofibers (e.g., in a layer) may comprise a copolymer (e.g., a copolymer that is an elastomer, such as a copolymer in which one of the repeat units therein forms microphase separated domains that crosslink the copolymer). Non-limiting examples of suitable types of copolymers include random copolymers, graft copolymers, and multiblock copolymers. Suitable multiblock copolymers include diblock copolymers, triblock copolymers, and copolymers comprising four or more blocks. Copolymers comprising three or more blocks may comprise two or more blocks that have the same chemical composition (e.g., in the case of an ABA triblock copolymer, in the case of a multiblock polymer comprising alternating A and B blocks) or may be made up of a combination of blocks that each have a different chemical composition.

It should be understood that when a layer comprises nanofibers comprising two or more copolymers, each copolymer may independently be of one or more of the types described above. Similarly, it should be understood that when two or more layers comprise nanofibers comprising copolymer(s), each layer comprising nanofibers may independently comprise one or more of the types of copolymers described above.

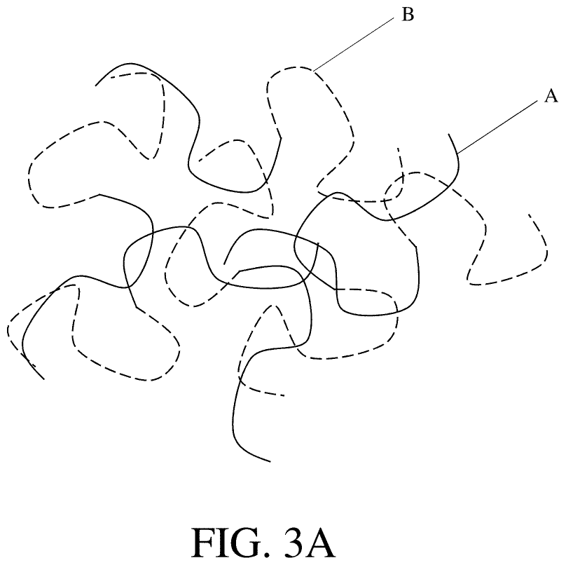

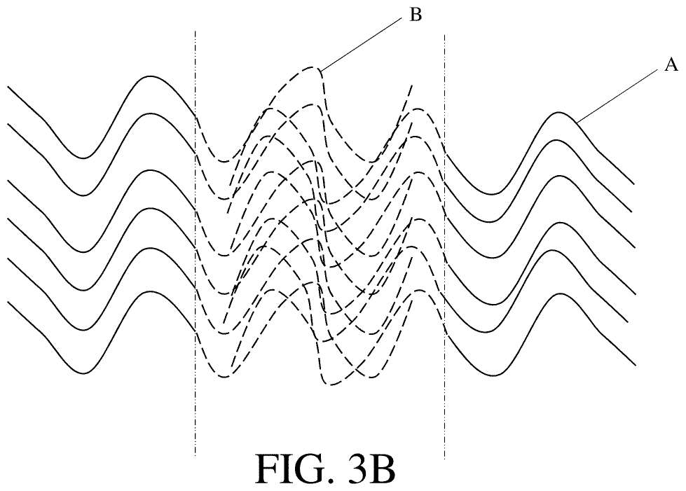

The nanofibers described herein may comprise microphase separated copolymers and/or may comprise copolymers that are not microphase separated. Without wishing to be bound by any particular theory, it is believed that microphase separation is the separation on a length scale of nanometers to hundreds of nanometers of portions of a copolymer having differing composition. The formation of microphase separated domains, their size, their spacing, and their morphology are believed to be governed by the chemical composition of the copolymer and the processing history of the copolymer. In brief, repeat units that are less compatible with each other are believed to promote microphase separation and the morphology of microphase separated domains that form is believed to be governed by the molecular weight of the polymer, the compatibility of the repeat units therein, and the relative amounts of the different repeat units therein. FIG. 3A shows one non-limiting embodiment of a diblock copolymer comprising A and B blocks that are not microphase separated, and FIG. 3B shows one non-limiting embodiment of a diblock copolymer comprising A and B blocks that are microphase separated and form lamellae. In FIG. 3B, the divisions between the lamellae comprising the A blocks and those comprising the B blocks are shown with dotted lines.

When a layer comprises nanofibers comprising a microphase separated copolymer, the microphase separated copolymer may have a variety of suitable morphologies. For instance, in some embodiments, the microphase separated copolymer may comprise microphase separated domains that are spherical, cylindrical, double gyroidal, lamellar, hexagonally perforated lamellar, and/or that form a matrix surrounding other microphase separated domains (e.g., that form a matrix surrounding spherical microphase separated domains, that form a matrix surrounding cylindrical microphase separated domains, that form a matrix surrounding double gyroidal microphase separated domains). Without wishing to be bound by any particular theory, it is believed that ABA triblock copolymers comprising a B block that has a glass transition temperature below 25° C. and having a morphology in which microphase separated domains comprising the B block form a matrix that surrounds microphase separated domains comprising the A block may exhibit particularly desirable elastomeric behavior (e.g., such copolymers may be capable of undergoing relatively large elastically recoverable deformation). It is believed that the B block in the matrix may both readily undergo elongation and be attached on both ends to A blocks, and so may be capable of readily undergoing a certain amount of recoverable elongation but may be prevented from undergoing irrecoverable macroscopic flow due to the presence of the crosslinks formed by the A blocks on both ends of the B block. It is also believed that multiblock copolymers comprising more than three blocks but including alternating A and B blocks (e.g., ABABA multiblock copolymers, ABABABA multiblock copolymers, ABABABABA multiblock copolymers, etc.) may also display similar behavior.

It should be understood that when a layer comprises nanofibers comprising two or more microphase separated copolymers, each microphase separated copolymer may independently have one or more of the morphologies described above. Similarly, it should be understood that when two or more layers comprise nanofibers comprising microphase separated copolymer(s), the morphology of each microphase separated copolymer may independently be one or more of those described above.

When a layer comprises nanofibers comprising a microphase separated copolymer, the microphase separated copolymer may comprise microphase separated domains having a variety of suitable average spacings. For instance, in some embodiments, the average spacing between unconnected microdomains (e.g., between spheres, between cylinders, between gyroids, between lamellae) is greater than or equal to 1 nm, greater than or equal to 2 nm, greater than or equal to 5 nm, greater than or equal to 7.5 nm, greater than or equal to 10 nm, greater than or equal to 15 nm, greater than or equal to 20 nm, greater than or equal to 25 nm, greater than or equal to 30 nm, greater than or equal to 35 nm, greater than or equal to 40 nm, greater than or equal to 45 nm, greater than or equal to 50 nm, or greater than or equal to 55 nm. In some embodiments, the average spacing between unconnected microdomains is less than or equal to 60 nm, less than or equal to 55 nm, less than or equal to 50 nm, less than or equal to 45 nm, less than or equal to 40 nm, less than or equal to 35 nm, less than or equal to 30 nm, less than or equal to 25 nm, less than or equal to 20 nm, less than or equal to 15 nm, less than or equal to 10 nm, less than or equal to 7.5 nm, less than or equal to 5 nm, or less than or equal to 2 nm. Combinations of the above-referenced ranges are also possible (e.g., greater than or equal to 1 nm and less than or equal to 60 nm, greater than or equal to 5 nm and less than or equal to 30 nm, or greater than or equal to 5 nm and less than or equal to 30 nm). Other ranges are also possible. The average spacing between microdomains may be determined by performing transmission electron microscopy and then applying appropriate statistical techniques to the resultant images.

It should be understood that when a layer comprises nanofibers comprising two or more microphase separated copolymers, each microphase separated copolymer may independently have an average spacing between unconnected microdomains in one or more of the ranges described above. Similarly, it should be understood that when two or more layers comprise nanofibers comprising one or more microphase separated copolymers, the average spacing between microdomains of the microphase separated copolymer(s) in each layer may independently fall within one or more of the ranges described above.

In some embodiments, a layer comprising nanofibers may comprise a copolymer comprising one or more microphase separated domains and/or blocks that have relatively low glass transition temperatures (e.g., a B block of an ABA triblock copolymer may have a relatively low glass transition temperature, a B block of a multiblock copolymer comprising alternating A and B blocks may have a relatively low glass transition temperature). Such microphase separated domains and/or blocks may be amorphous at temperatures above their glass transition temperature(s) and/or, as described above, may readily undergo elongation at temperatures above their glass transition temperature(s). For instance, in some embodiments, the copolymer comprises one or more microphase separated domains and/or blocks having a glass transition temperature of less than or equal to 100° C., less than or equal to 75° C., less than or equal to 50° C., less than or equal to 30° C., less than or equal to 25° C., less than or equal to 20° C., less than or equal to 15° C., less than or equal to 10° C., less than or equal to 5° C., less than or equal to 0° C., less than or equal to −5° C., less than or equal to −10° C., less than or equal to −15° C., less than or equal to −20° C., less than or equal to −30° C., less than or equal to −50° C., or less than or equal to −75° C. The microphase separated domain(s) and/or block(s) may have a glass transition temperature of greater than or equal to −100° C., greater than or equal to −75° C., greater than or equal to −50° C., greater than or equal to −20° C., greater than or equal to −15° C., greater than or equal to −10° C., greater than or equal to −5° C., greater than or equal to 0° C., greater than or equal to 5° C., greater than or equal to 10° C., greater than or equal to 15° C., greater than or equal to 20° C., greater than or equal to 25° C., greater than or equal to 50° C., or greater than or equal to 75° C. Combinations of the above-referenced ranges are also possible (e.g., less than or equal to 100° C. and greater than or equal to −100° C., less than or equal to 50° C. and greater than or equal to −50° C., or less than or equal to 0° C. and greater than or equal to −20° C.). Other ranges are also possible. The glass transition temperature of a microphase separated domain of copolymer may be determined by differential scanning calorimetry on the first heating cycle. The first heating cycle may be performed from an initial temperature of −50° C. and at a ramp rate of 10° C. per minute. If the block does not form a microphase separated domain, its glass transition temperature may be determined by: (1) Identifying the polymer forming the block by nuclear magnetic resonance; and (2) Consulting the Polymer Handbook (1989) for the measured glass transition temperature of the polymer forming the block.

It should be understood that when a layer comprises nanofibers comprising two or more copolymers, each copolymer may independently comprise one or more microphase separated domains and/or one or more blocks having a glass transition in one or more of the ranges described above. Similarly, it should be understood that when two or more layers comprise nanofibers comprising copolymers, the glass transition temperature(s) of the microphase separated domains and/or one or more blocks of the copolymer(s) in each layer may independently fall within one or more of the ranges described above.

As also described above, in some embodiments, a layer comprising nanofibers may comprise a copolymer comprising one or more microphase separated domains and/or blocks that have relatively high glass transition temperatures (e.g., the A blocks of an ABA triblock copolymer may have a relatively high glass transition temperature, the A block of a multiblock copolymer comprising alternating A and B blocks may have a relatively high glass transition temperature). Such microphase separated domains and/or blocks may be at least partially amorphous at temperatures below their glass transition temperature(s) and/or, as described above, may serve as crosslinks. For instance, in some embodiments, the copolymer comprises one or more microphase separated domains and/or blocks having a glass transition temperature of greater than or equal to 30° C., greater than or equal to 40° C., greater than or equal to 50° C., greater than or equal to 60° C., greater than or equal to 70° C., greater than or equal to 80° C., greater than or equal to 100° C., greater than or equal to 120° C., greater than or equal to 140° C., greater than or equal to 150° C., greater than or equal to 160° C., greater than or equal to 170° C., greater than or equal to 180° C., greater than or equal to 200° C., or greater than or equal to 225° C. The microphase separated domain(s) and/or blocks may have a glass transition temperature of less than or equal to 250° C., less than or equal to 225° C., less than or equal to 200° C., less than or equal to 180° C., less than or equal to 170° C., less than or equal to 160° C., less than or equal to 150° C., less than or equal to 140° C., less than or equal to 120° C., less than or equal to 100° C., less than or equal to 80° C., less than or equal to 70° C., less than or equal to 60° C., less than or equal to 50° C., or less than or equal to 40° C. Combinations of the above-referenced ranges are also possible (e.g., greater than or equal to 30° C. and less than or equal to 250° C., greater than or equal to 30° C. and less than or equal to 200° C., greater than or equal to 40° C. and less than or equal to 180° C., or greater than or equal to 70° C. and less than or equal to 170° C.). Other ranges are also possible. The glass transition of the microphase separated domain(s) and/or block(s) may be measured as described elsewhere herein.

It should be understood that when a layer comprises nanofibers comprising two or more copolymers, each copolymer may independently comprise one or more microphase separated domains and/or one or more blocks having a glass transition in one or more of the ranges described above. Similarly, it should be understood that when two or more layers comprise nanofibers comprising copolymers, the glass transition temperature(s) of the microphase separated domains and/or one or more blocks of the copolymer(s) in each layer may independently fall within one or more of the ranges described above.

In some embodiments, a layer comprising nanofibers may comprise a copolymer comprising one or more microphase separated domains and/or blocks that are crystalline and/or semicrystalline at 25° C. (e.g., the A blocks of an ABA triblock copolymer may be crystalline and/or semicrystalline at 25° C., the A blocks of a multiblock copolymer comprising alternating A and B blocks may be crystalline and/or semicrystalline at 25° C.). As described above, such microphase separated domain(s) and/or blocks may serve as crosslinks. For instance, in some embodiments, a copolymer comprises one or more microphase separated domains and/or blocks having a melting point of greater than or equal to 100° C., greater than or equal to 105° C., greater than or equal to 110° C., greater than or equal to 120° C., greater than or equal to 130° C., greater than or equal to 140° C., greater than or equal to 150° C., greater than or equal to 175° C., greater than or equal to 200° C., greater than or equal to 225° C., greater than or equal to 250° C., or greater than or equal to 275° C. In some embodiments, a copolymer may comprise one or more microphase separated domains and/or blocks having a melting point of less than or equal to 300° C., less than or equal to 275° C., less than or equal to 250° C., less than or equal to 225° C., less than or equal to 200° C., less than or equal to 175° C., less than or equal to 150° C., less than or equal to 140° C., less than or equal to 130° C., less than or equal to 120° C., less than or equal to 110° C., or less than or equal to 105° C. Combinations of the above-referenced ranges are also possible (e.g., greater than or equal to 100° C. and less than or equal to 300° C., greater than or equal to 110° C. and less than or equal to 250° C., or greater than or equal to 120° C. and less than or equal to 200° C.). Other ranges are also possible. The melting point of a microphase separated domain of copolymer may be determined by differential scanning calorimetry as described above. If the block does not form a microphase separated domain, its melting point may be determined by: (1) Identifying the polymer forming the block by nuclear magnetic resonance; and (2) Consulting a reference listing the measured melting points of polymers.

It should be understood that when a layer comprises nanofibers comprising two or more copolymers, each copolymer may independently comprise one or more microphase separated domains and/or one or more blocks having a melting point in one or more of the ranges described above. Similarly, it should be understood that when two or more layers comprise nanofibers comprising copolymers, the melting point(s) of the microphase separated domains and/or one or more blocks of the copolymer(s) in each layer may independently fall within one or more of the ranges described above.

When present in nanofibers (e.g., in a layer comprising nanofibers), copolymers may comprise a variety of suitable types of repeat units. For instance, in some embodiments, a copolymer comprises one or more of the following types of repeat units: repeat units comprising an ether group, repeat units comprising an amide group, repeat units comprising an ester group, repeat units comprising a carbamate group, repeat units comprising a sulfone group, repeat units comprising a carbonate group, repeat units comprising a urea group, repeat units comprising an amic acid group, repeat units comprising an imide group, repeat units comprising a ketone group, repeat units formed by polymerization of caprolactam monomers, repeat units formed by polymerization of ester monomers, repeat units formed by polymerization of styrene monomers, repeat units formed by polymerization of diene monomers (e.g., repeat units formed by polymerization of butadiene monomers, repeat units formed by polymerization of isoprene monomers), repeat units formed by polymerization of fluorinated monomers (e.g., repeat units formed by polymerization of vinylidene difluoride monomers, repeat units formed by polymerization of hexafluoropropylene monomers), repeat units formed by polymerization of olefin monomers (e.g., repeat units formed by polymerization of ethylene monomers, repeat units formed by polymerization of propylene monomers), repeat units formed by polymerization of acrylonitrile monomers, repeat units formed by polymerization of acrylic monomers, and repeat units formed by polymerization of vinyl monomers.

It should be understood that when a layer comprises nanofibers comprising two or more copolymers, each copolymer may independently comprise one or more of the repeat units described above. Similarly, it should be understood that when two or more layers comprise nanofibers comprising copolymers, the copolymer(s) in each layer may independently comprise one or more of the repeat units described above.

When a layer comprises nanofibers comprising one or more multiblock copolymers, the blocks therein may have a variety of suitable compositions. By way of example, the multiblock copolymers may comprise one or more of the following blocks: poly(amide) blocks (e.g., Nylon 11 blocks, Nylon 12 blocks), poly(ether) blocks (e.g., poly(tetrahydrofuran) blocks), poly(ester) blocks, poly(styrene) blocks, poly(diene) blocks (e.g., poly(butadiene) blocks), blocks comprising a reaction product of a chain extender and a diisocyanate, and poly(urethane) blocks. When a multiblock copolymer comprises two or more blocks of the same type, each block of the same type may have a different chemical composition or two or more blocks of the same type may have the same chemical composition. By way of example, a multiblock copolymer may comprise two or more different poly(amide) blocks (e.g., one Nylon 11 block and one Nylon 12 block) and/or may comprise two or more identical poly(amide blocks (e.g., two Nylon 11 blocks).

It should be understood that when a layer comprises nanofibers comprising two or more multiblock copolymers, each multiblock copolymer may independently comprise one or more of the blocks described above. Similarly, it should be understood that when two or more layers comprise nanofibers comprising multiblock copolymers, the multiblock copolymer(s) in each layer may independently comprise one or more of the blocks described above.

In some embodiments, a multiblock copolymer comprises both one or more poly(ether) blocks and one or more poly(amide) blocks. The poly(ether) blocks may have a relatively low glass transition temperature (e.g., below 25° C.) and/or the poly(amide) blocks may be glassy, crystalline, and/or semicrystalline. In some embodiments, the poly(amide) blocks may microphase separate from the poly(ether) blocks to form discontinuous microphase separated domains embedded in a matrix comprising the poly(ether) blocks. As described elsewhere herein, this combination of properties may cause poly(amide) blocks to serve as crosslinks. One example of a suitable multiblock copolymer comprising both one or more poly(amide) blocks and one or more poly(ether) blocks is a multiblock copolymer comprising one or more Nylon 11 blocks and one or more poly(tetrahydrofuran) blocks. As another example, a multiblock copolymer may comprise one or more Nylon 12 blocks and one or more poly(tetrahydrofuran) blocks. In some embodiments, a multiblock copolymer comprises alternating poly(amide) and poly(tetrahydrofuran) blocks.

It should be understood that when a layer comprises nanofibers comprising two or more multiblock copolymers, each multiblock copolymer may independently have one or more of the compositions described above. Similarly, it should be understood that when two or more layers comprise nanofibers comprising multiblock copolymers, the multiblock copolymer(s) in each layer may independently have one or more of the compositions described above.

Other non-limiting examples of suitable multiblock copolymers include those comprising one or more poly(ester) blocks and one or more poly(ether) blocks, those comprising one or more poly(styrene) blocks and one or more poly(diene) blocks (e.g., multiblock copolymers comprising one or more poly(isoprene) blocks and one or more poly(styrene) blocks, multiblock copolymers comprising one or more poly(butadiene) blocks and one or more poly(styrene blocks), Kratons, ABA triblock copolymers comprising poly(diene) B blocks and poly(styrene) A blocks), and segmented poly(urethane)s.

It should be understood that when a layer comprises nanofibers comprising two or more multiblock copolymers, each multiblock copolymer may independently have one or more of the compositions described above. Similarly, it should be understood that when two or more layers comprise nanofibers comprising multiblock copolymers, the multiblock copolymer(s) in each layer may independently have one or more of the compositions described above.

When a layer comprising nanofibers comprises nanofibers comprising one or more multiblock copolymers comprising one or more poly(amide) blocks, the poly(amide) blocks may make up a variety of suitable amounts of the multiblock copolymer. By way of example, in some embodiments, the poly(amide) block(s) make up greater than or equal to 15 mol %, greater than or equal to 20 mol %, greater than or equal to 25 mol %, greater than or equal to 30 mol %, greater than or equal to 40 mol %, greater than or equal to 50 mol %, or greater than or equal to 75 mol % of the multiblock copolymer. In some embodiments, the poly(amide) block(s) make up less than 100 mol %, less than or equal to 75 mol %, less than or equal to 50 mol %, less than or equal to 40 mol %, less than or equal to 30 mol %, less than or equal to 25 mol %, or less than or equal to 20 mol % of the multiblock copolymer. Combinations of the above-referenced ranges are also possible (e.g., greater than or equal to 15 mol % and less than 100 mol %, or greater than or equal to 20 mol % and less than or equal to 40 mol %). Other ranges are also possible. The mol % of the poly(amide) blocks may be determined by: (1) Measuring the composition of the multiblock copolymer by nuclear magnetic resonance; and (2) Calculating the mol % of the poly(amide) blocks based on the measured composition.

It should be understood that when a layer comprises nanofibers comprising two or more multiblock copolymers, each multiblock copolymer may independently comprise poly(amide) block(s) making up an amount thereof in one or more of the ranges described above. Similarly, it should be understood that when two or more layers comprise nanofibers comprising multiblock copolymers, the multiblock copolymer(s) in each layer may independently comprise poly(amide) block(s) making up an amount thereof in one or more of the ranges described above.

As described above, some nanofibers (e.g., some nanofibers in a layer comprising nanofibers) may comprise random copolymers. Non-limiting examples of suitable random copolymers include random copolymers comprising repeat units formed by polymerization of two or more different types of fluorinated monomers (e.g., random copolymers comprising repeat units formed by polymerization of vinylidene difluoride monomers and repeat units formed by polymerization of hexafluoropropylene monomers), random copolymers comprising repeat units formed by polymerization of styrene monomers and repeat units formed by polymerization of diene monomers (e.g., random copolymers comprising repeat units formed by polymerization of styrene monomers and repeat units formed by polymerization of butadiene monomers, random copolymers comprising repeat units formed by polymerization of styrene monomers and repeat units formed by polymerization of isoprene monomers), random copolymers comprising repeat units formed by polymerization of two or more different types of olefin monomers (e.g., random copolymers comprising repeat units formed by polymerization of ethylene monomers and repeat units formed by polymerization of propylene monomers), random copolymers comprising repeat units formed by polymerization of acrylonitrile monomers and repeat units formed by polymerization of butadiene monomers, and EPDM rubber.

It should be understood that when a layer comprises nanofibers comprising two or more random copolymers, each random copolymer may independently have one or more of the compositions described above. Similarly, it should be understood that when two or more layers comprise nanofibers comprising random copolymers, the random copolymer(s) in each layer may independently have one or more of the compositions described above.

As also described above, some nanofibers (e.g., some nanofibers in a layer comprising nanofibers) may comprise covalently crosslinked polymers. For instance, a covalently crosslinked polymer may comprise crosslinks formed by the reaction of small molecule crosslinkers with a polymer and/or prepolymer. In some embodiments, a covalently crosslinked polymer is a homopolymer. Non-limiting examples of covalently crosslinked polymers include vulcanized rubber, poly(urethane)s, and siloxanes (e.g., RTV silicone). In some embodiments, and as described above, a covalently crosslinked polymer comprises crosslinks that arises from the inherent chemical structure of a polymer. Non-limiting examples of such polymers include natural rubber, poly(butadiene), siloxanes, and chlorinated polymers (e.g., poly(chloroprene)).

It should be understood that when a layer comprises nanofibers comprising two or more covalently crosslinked polymers, each covalently crosslinked polymer may independently have one or more of the compositions described above. Similarly, it should be understood that when two or more layers comprise nanofibers comprising covalently crosslinked polymers, the covalently crosslinked polymer(s) in each layer may independently have one or more of the compositions described above.

In some embodiments, a layer comprises nanofibers comprising an uncrosslinked polymer. The uncrosslinked polymer may be present in addition to a crosslinked polymer and/or may be blended with a crosslinked polymer. As one example, a layer may comprise nanofibers comprising a multiblock copolymer comprising one or more poly(ether) blocks and one or more poly(amide) blocks and may further comprise a poly(amide) homopolymer (e.g., a Nylon 6 homopolymer, a homopolymer having the same composition as one of the poly(amide) blocks).

It should be understood that when a layer comprises nanofibers comprising two or more uncrosslinked polymers, each uncrosslinked polymer may independently have one or more of the compositions described above. Similarly, it should be understood that when two or more layers comprise nanofibers comprising uncrosslinked polymers, the each layer may independently have one or more of the compositions described above.

When present, a layer comprising nanofibers may comprise nanofibers having a variety of suitable morphologies. For instance, in some embodiments, a layer may comprise nanofibers that are substantially cylindrical, nanofibers that are ribbon-like, and/or nanofibers that are at least partially fibrillated. Without wishing to be bound by any particular theory, it is believed that the presence of nanofibers that are ribbon-like and/or that are at least partially fibrillated may be advantageous. For instance, nanofibers that are at least partially fibrillated may enhance the efficiency of the layer in which they are positioned, exhibit reduced air drag, and/or reduce the mean flow pore size of the layer in which they are positioned.

It should be understood that when two or more layers comprise nanofibers, each layer comprising nanofibers may independently comprise nanofibers that are substantially cylindrical, nanofibers that are ribbon-like, and/or nanofibers that are at least partially fibrillated.

As used herein, nanofibers that are substantially cylindrical have a cross-section for which the ratio of the longest diameter that may be drawn across the cross-section to the shortest diameter that may be drawn across the cross-section is less than 2:1. In some embodiments, a nanofiber that is substantially cylindrical has a ratio of the longest diameter that may be drawn across the cross-section to the shortest diameter that may be drawn across the cross-section of less than 2:1, less than or equal to 1.75:1, less than or equal to 1.5:1, or less than or equal to 1.25:1. In some embodiments, a nanofiber that is substantially cylindrical has a ratio of the longest diameter that may be drawn across the cross-section to the shortest diameter that may be drawn across the cross-section of greater than or equal to 1:1, greater than or equal to 1.25:1, greater than or equal to 1.5:1, or greater than or equal to 1.75:1. Combinations of the above-referenced ranges are also possible (e.g., less than 2:1 and greater than or equal to 1:1). Other ranges are also possible.

It should be understood that when two or more layers comprise nanofibers, each layer comprising nanofibers may independently comprise nanofibers having a ratio of the longest diameter that may be drawn across the cross-section to the shortest diameter that may be drawn across the cross-section in one or more of the ranges described above.

As used herein, nanofibers that are ribbon-like have a cross-section for which the ratio of the longest diameter that may be drawn across the cross-section to the shortest diameter that may be drawn across the cross-section is greater than or equal to 2:1. In some embodiments, a nanofiber that is ribbon-like has a ratio of the longest diameter that may be drawn across the cross-section to the shortest diameter that may be drawn across the cross-section of greater than or equal to 2:1, greater than or equal to 3:1, greater than or equal to 4:1, greater than or equal to 5:1, greater than or equal to 7.5:1, greater than or equal to 10:1, or greater than or equal to 15:1. In some embodiments, a nanofiber that is ribbon-like has a ratio of the longest diameter that may be drawn across the cross-section to the shortest diameter that may be drawn across the cross-section of less than or equal to 20:1, less than or equal to 15:1, less than or equal to 7.5:1, less than or equal to 5:1, less than or equal to 4:1, or less than or equal to 3:1. Combinations of the above-referenced ranges are also possible (e.g., greater than or equal to 2:1 and less than or equal to 20:1). Other ranges are also possible.

It should be understood that when two or more layers comprise nanofibers, each layer comprising nanofibers may independently comprise nanofibers having a ratio of the longest diameter that may be drawn across the cross-section to the shortest diameter that may be drawn across the cross-section in one or more of the ranges described above.

As known to those of ordinary skill in the art, a fibrillated fiber includes a parent fiber that splits into smaller width fibrils, which can, in some instances, split further out into even smaller width fibrils with further splitting also being possible. Accordingly, layer comprising at least partially fibrillated nanofibers may comprise both nanofibers having fiber widths indicative of parent nanofibers and/or unfibrillated nanofibers (e.g., fiber widths indicative of ribbon-like nanofibers, fiber widths indicative of unfibrillated and substantially cylindrical nanofibers) and fibrils having fiber widths indicative of fibrillated fibers. The split nature of the fibrils may enhance the surface area of a layer in which the fibrillated fibers are employed, reduce the mean flow pore size, and/or increase the number of contact points between the fibrillated fibers and other fibers in the layer. This morphology may reduce the drag and/or enhance the capture efficiency of the layer comprising the fibrillated fibers.

When present, a layer comprising nanofibers may comprise nanofibers having a variety of suitable mean fiber widths. In some embodiments, a layer comprising nanofibers comprises nanofibers having a mean fiber width of greater than or equal to 50 nm, greater than or equal to 60 nm, greater than or equal to 75 nm, greater than or equal to 90 nm, greater than or equal to 100 nm, greater than or equal to 125 nm, greater than or equal to 150 nm, greater than or equal to 175 nm, greater than or equal to 200 nm, greater than or equal to 225 nm, greater than or equal to 250 nm, greater than or equal to 275 nm, greater than or equal to 300 nm, greater than or equal to 325 nm, greater than or equal to 350 nm, greater than or equal to 400 nm, greater than or equal to 450 nm, greater than or equal to 500 nm, greater than or equal to 550 nm, greater than or equal to 650 nm, or greater than or equal to 700 nm. In some embodiments, a layer comprising nanofibers comprises nanofibers having a mean fiber width of less than or equal to 750 nm, less than or equal to 700 nm, less than or equal to 650 nm, less than or equal to 550 nm, less than or equal to 500 nm, less than or equal to 450 nm, less than or equal to 400 nm, less than or equal to 350 nm, less than or equal to 325 nm, less than or equal to 300 nm, less than or equal to 275 nm, less than or equal to 250 nm, less than or equal to 225 nm, less than or equal to 200 nm, less than or equal to 175 nm, less than or equal to 150 nm, less than or equal to 125 nm, less than or equal to 100 nm, less than or equal to 90 nm, less than or equal to 75 nm, or less than or equal to 60 nm. Combinations of the above-referenced ranges are also possible (e.g., greater than or equal to 50 nm and less than or equal to 750 nm, greater than or equal to 50 nm and less than or equal to 500 nm, greater than or equal to 75 nm and less than or equal to 350 nm, greater than or equal to 75 nm and less than or equal to 300 nm, or greater than or equal to 90 nm and less than or equal to 350 nm). Other ranges are also possible. The mean fiber width may be determined by scanning electron microscopy. As used herein, the mean fiber width refers to the average of the largest cross-sectional diameters of the fibers.

It should be understood that when two or more layers comprise nanofibers, each layer comprising nanofibers may independently comprise nanofibers having a mean fiber width in one or more of the ranges described above.

When present, nanofibers that are at least partially fibrillated comprise fibrils having relatively small fiber widths. For instance, fibrillated nanofibers may comprise fibrils having mean fiber widths of less than or equal to 100 nm, less than or equal to 90 nm, less than or equal to 80 nm, less than or equal to 70 nm, or less than or equal to 60 nm. The fibrillated nanofibers may comprise fibrils having mean fiber widths of greater than or equal to 50 nm, greater than or equal to 60 nm, greater than or equal to 70 nm, greater than or equal to 80 nm, or greater than or equal to 90 nm. Combinations of the above-referenced ranges are also possible (e.g., less than or equal to 100 and greater than or equal to 50 nm, or less than or equal to 80 and greater than or equal to 50 nm). Other ranges are also possible. The mean fiber width of the fibrils may be determined by scanning electron microscopy. As used herein, the mean fiber width of the fibrils refers to the average of the largest cross-sectional diameters of the fibrils.

It should be understood that when two or more layers comprise nanofibers that are at least partially fibrillated, each layer comprising nanofibers that are at least partially fibrillated may independently comprise fibrils having a mean fiber width in one or more of the ranges described above.

When a layer comprises nanofibers that are at least partially fibrillated, fibrils may make up an appreciable percentage of the total number of nanofibers. This may be evidenced by nanofibers having fiber widths indicative of fibrils making up an appreciable percentage of the total amount of nanofibers. For instance, in some embodiments, nanofibers having a fiber width indicative of fibrils (e.g., less than or equal to 100 nm and greater than or equal to 50 nm, less than or equal to 80 nm and greater than or equal to 50 nm) make up greater than or equal to 5%, greater than or equal to 10%, greater than or equal to 15%, or greater than or equal to 20% of the total amount of nanofibers. In some embodiments, nanofibers having a fiber width indicative of fibrils make up less than or equal to 30%, less than or equal to 20%, less than or equal to 15%, or less than or equal to 10% of the total amount of nanofibers. Combinations of the above-referenced ranges are also possible (e.g., greater than or equal to 5% and less than or equal to 30%, greater than or equal to 10% and less than or equal to 30%, greater than or equal to 10% and less than or equal to 30%, or greater than or equal to 20% and less than or equal to 30%). Other ranges are also possible. The fiber width of nanofibers may be determined by scanning electron microscopy. As used herein, the fiber width of a nanofiber refers to the average of the largest cross-sectional diameters of the nanofiber.

It should be understood that when two or more layers comprise nanofibers that are at least partially fibrillated, each layer comprising nanofibers that are at least partially fibrillated may independently comprise an amount of nanofibers having fiber widths indicative of fibrils in one or more of the ranges described above.

When present, ribbon-like nanofibers may have relatively large fiber widths. For instance, ribbon-like nanofibers may have mean fiber widths of greater than or equal to 200 nm, greater than or equal to 225 nm, greater than or equal to 250 nm, greater than or equal to 275 nm, greater than or equal to 300 nm, greater than or equal to 325 nm, greater than or equal to 350 nm, greater than or equal to 400 nm, greater than or equal to 450 nm, greater than or equal to 500 nm, greater than or equal to 550 nm, greater than or equal to 650 nm, or greater than or equal to 700 nm. The ribbon-like nanofibers may have mean fiber widths of less than or equal to 500 nm, less than or equal to 750 nm, less than or equal to 700 nm, less than or equal to 650 nm, less than or equal to 550 nm, less than or equal to 450 nm, less than or equal to 400 nm, less than or equal to 350 nm, less than or equal to 325 nm, less than or equal to 300 nm, less than or equal to 275 nm, less than or equal to 250 nm, or less than or equal to 225 nm. Combinations of the above-referenced ranges are also possible (e.g., greater than or equal to 200 nm and less than or equal to 750 nm, greater than or equal to 200 nm and less than or equal to 500 nm, or greater than or equal to 250 nm and less than or equal to 500 nm). Other ranges are also possible. The mean fiber width of the ribbon-like nanofibers may be determined by scanning electron microscopy. As used herein, the mean fiber width of the ribbon-like nanofibers refers to the average of the largest cross-sectional diameters of the ribbon-like nanofibers.

It should be understood that when two or more layers comprise ribbon-like nanofibers, each layer comprising ribbon-like nanofibers may independently comprise ribbon-like nanofibers having a mean fiber width in one or more of the ranges described above.

When a layer comprises ribbon-like nanofibers (e.g., ribbon-like nanofibers having a mean fiber width in one or more of the ranges described above), the ribbon-like nanofibers may make up an appreciable percentage of the total number of nanofibers. In some embodiments, ribbon-like nanofibers (e.g., ribbon-like nanofibers having a mean fiber width in one or more of the ranges described above, such as greater than or equal to 200 nm and less than or equal to 500 nm or greater than or equal to 250 nm and less than or equal to 500 nm) make up greater than or equal to 3%, greater than or equal to 5%, greater than or equal to 9%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 60%, greater than or equal to 70%, greater than or equal to 80%, or greater than or equal to 90% of the total amount of nanofibers. In some embodiments, ribbon-like nanofibers make up less than or equal to 100%, less than or equal to 90%, less than or equal to 80%, less than or equal to 70%, less than or equal to 60%, less than or equal to 50%, less than or equal to 45%, less than or equal to 40%, less than or equal to 35%, less than or equal to 30%, less than or equal to 25%, less than or equal to 20%, less than or equal to 15%, less than or equal to 9%, or less than or equal to 5% of the total amount of nanofibers. Combinations of the above-referenced ranges are also possible (e.g., greater than or equal to 3% and less than or equal to 100%, greater than or equal to 3% and less than or equal to 70%, greater than or equal to 9% and less than or equal to 70%, greater than or equal to 40% and less than or equal to 70%, or greater than or equal to 50% and less than or equal to 70%). In some embodiments, 100% of the nanofibers in a layer are ribbon-like nanofibers. Other ranges are also possible.

It should be understood that when two or more layers comprise nanofibers, each layer comprising nanofibers may independently comprise an amount of ribbon-like nanofibers having a mean fiber width in one or more of the ranges described above in one or more of the ranges described above.

When present, a layer comprising nanofibers may comprise nanofibers having a variety of suitable distributions of fiber width. Without wishing to be bound by any particular theory, it is believed that, because ribbon-like fibers tend to have larger fiber widths than other types of nanofibers, the presence of ribbon-like fibers in a layer comprising nanofibers may result in a distribution of fiber widths for which the ratio of the third quartile fiber width (i.e., the fiber width which is greater than 75% of the fiber widths of the nanofibers in the nanofiber layer and less than 25% of the fiber widths of the nanofibers in the nanofiber layer) to the modal fiber width is relatively high. Because fibrillated fibers comprise fibrils having smaller fiber widths than the parent fibers, it is believed that the presence of fibrillated fibers in a layer comprising nanofibers may result in a distribution of fiber widths for which the ratio of the first quartile fiber width (i.e., the fiber width which is greater than 25% of the fiber widths of the nanofibers in the nanofiber layer and less than 75% of the fiber widths of the nanofibers in the nanofiber layer) to the modal fiber width that is relatively low. As used herein, the width of a fiber refers to its largest cross-sectional diameter.

In some embodiments, a layer comprising nanofibers comprises nanofibers having a ratio of third quartile fiber width to modal fiber width of greater than or equal to 1.4, greater than or equal to 1.5, greater than or equal to 1.6, greater than or equal to 1.7, greater than or equal to 1.8, greater than or equal to 1.9, greater than or equal to 2, greater than or equal to 2.1, greater than or equal to 2.2, greater than or equal to 2.3, greater than or equal to 2.4, or greater than or equal to 2.5. In some embodiments, a layer comprising nanofibers comprises nanofibers having a ratio of third quartile fiber width to modal fiber width of less than or equal to 3, less than or equal to 2.5, less than or equal to 2.4, less than or equal to 2.3, less than or equal to 2.2, less than or equal to 2.1, less than or equal to 2, less than or equal to 1.9, less than or equal to 1.8, less than or equal to 1.7, less than or equal to 1.6, or less than or equal to 1.5. Combinations of the above-referenced ranges are also possible (e.g., greater than or equal to 1.4 and less than or equal to 3, or greater than or equal to 2 and less than or equal to 3). Other ranges are also possible.

It should be understood that when two or more layers comprise nanofibers, each layer comprising nanofibers may independently comprise nanofibers having a ratio of third quartile fiber width to modal fiber width in one or more of the ranges described above.

In some embodiments, a layer comprising nanofibers comprises nanofibers having a ratio of first quartile fiber width to modal fiber width of less than or equal to 1, less than or equal to 0.95, or less than or equal to 0.9. In some embodiments, a layer comprising nanofibers comprises nanofibers having a ratio of first quartile fiber width to modal fiber width of greater than or equal to 0.85, greater than or equal to 0.9, or greater than or equal to 0.95. Combinations of the above-referenced ranges are also possible (e.g., less than or equal to 1 and greater than or equal to 0.85, or less than or equal to 1 and greater than or equal to 0.9). Other ranges are also possible.

It should be understood that when two or more layers comprise nanofibers, each layer comprising nanofibers may independently comprise nanofibers having a ratio of first quartile fiber width to modal fiber width in one or more of the ranges described above.

When present, a layer comprising nanofibers may have a relatively broad distribution of fiber widths. For instance, in some embodiments, a layer comprising nanofibers may have a coefficient of variation of fiber width of greater than or equal to 0.35, greater than or equal to 0.4 greater than or equal to 0.45, greater than or equal to 0.5, greater than or equal to 0.6, greater than or equal to 0.7, greater than or equal to 0.8, or greater than or equal to 0.9. In some embodiments, a layer comprising nanofibers may have a coefficient of variation of fiber width of less than or equal to 1, less than or equal to 0.9, less than or equal to 0.8, less than or equal to 0.7, less than or equal to 0.6, less than or equal to 0.5, less than or equal to 0.45, or less than or equal to 0.4. Combinations of the above-referenced ranges are also possible (e.g., greater than or equal to 0.35 and less than or equal to 1, or greater than or equal to 0.35 and less than or equal to 0.5). Other ranges are also possible. The coefficient of variation of fiber width may be determined by scanning electron microscopy. As used herein, the coefficient of variation of fiber width refers to the ratio of the standard deviation of fiber width to the mean fiber width.

As another example, a layer comprising nanofibers may have a ratio of interquartile distance (i.e., the difference between the third quartile fiber width and the first quartile fiber width) to modal fiber width of greater than or equal to 0.5, greater than or equal to 0.6, greater than or equal to 0.7, greater than or equal to 0.8, greater than or equal to 0.9, greater than or equal to 1, greater than or equal to 1.1, greater than or equal to 1.2, greater than or equal to 1.3, greater than or equal to 1.4, or greater than or equal to 1.5. A layer comprising nanofibers may have a ratio of interquartile distance to modal fiber width of less than or equal to 2, less than or equal to 1.5, less than or equal to 1.4, less than or equal to 1.3, less than or equal to 1.2, less than or equal to 1.1, less than or equal to 1, less than or equal to 0.9, less than or equal to 0.8, less than or equal to 0.7, or less than or equal to 0.6. Combinations of the above-referenced ranges are also possible (e.g., greater than or equal to 0.5 and less than or equal to 2, greater than or equal to 0.6 and less than or equal to 2, or greater than or equal to 1.5 and less than or equal to 2). Other ranges are also possible.

It should be understood that when two or more layers comprise nanofibers, each layer comprising nanofibers may independently comprise nanofibers having a ratio of first interquartile distance to modal fiber width in one or more of the ranges described above.

When present, a layer comprising nanofibers may comprise loft enhancing agents, such as nanoparticles. The loft enhancing agents may serve to advantageously reduce the solidity of the layer comprising nanofibers. In some embodiments, a layer comprising nanofibers comprises loft enhancing agents that are nanoparticulate.

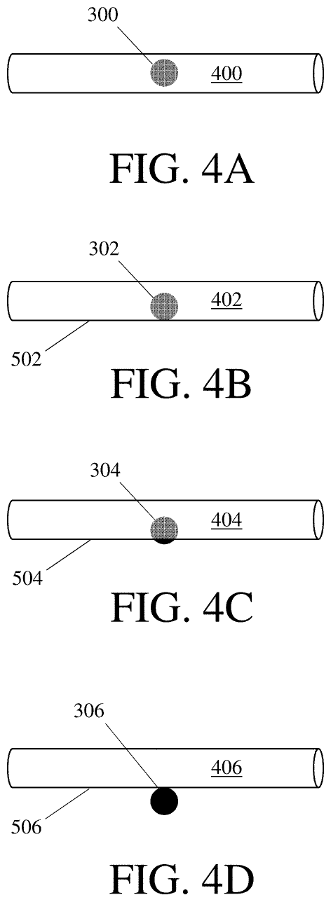

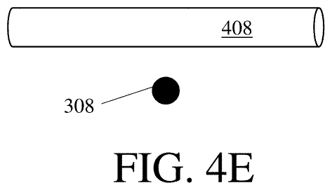

When a plurality of nanofibers comprises a plurality of nanoparticles, the nanoparticles may be positioned with respect to the nanofibers in a variety of suitable manners. In some embodiments, at least a portion (or substantially all) of the nanoparticles are at least partially embedded therein. By way of example, at least a portion (or substantially all) of the nanoparticles may be located in an interior of a nanofiber. When a nanoparticle is located in an interior of a nanofiber, it is completely or fully embedded therein. In other words, it is surrounded on all sides by other components of the nanofiber and all of its external surface is in contact with other components of the nanofiber. FIG. 4A shows one example of a nanoparticle located in an interior of a nanofiber. In FIG. 4A, a nanoparticle 300 is located in the interior of a nanofiber 400. In some embodiments, like the embodiment shown in FIG. 4A, the external surface of a nanofiber comprising a nanoparticle located in its interior does not show any indication of the presence of the nanoparticle. The external surface of the nanofiber may be substantially the same as the external surface of an otherwise equivalent nanofiber lacking the nanoparticle and/or may not include any protrusions or other features indicative of the presence of nanoparticles therein. In some embodiments, the presence of such nanoparticles are not observable by SEM. When nanoparticles are located in the interior of a nanofiber, they may be located in the interior of the same nanofiber (e.g., one nanofiber may comprise all the nanoparticles in the plurality of nanoparticles in its interior) or located in the interiors of more than one (or substantially all) of the nanofibers in the plurality of nanofibers (e.g., two or more nanofibers may comprise nanoparticles in their interiors, and all of the nanoparticles in the plurality of nanoparticles may be located interior to one of the fibers in the plurality of nanofibers).

In some embodiments, at least a portion (or substantially all) of the nanoparticles are located at a surface of a nanofiber. When a nanoparticle is located at a surface of a nanofiber, it comprises a portion that makes up a part of the surface of the nanofiber. In other words, at least a portion of the surface of the nanoparticle is not in contact with the other components of the nanofiber and is exposed to an environment external to the nanofiber. FIGS. 4B-4C show different examples of nanoparticles located at the surfaces of nanofibers. In some embodiments, like the embodiment shown in FIG. 4B, the portion of the nanoparticle at the surface of the nanofiber does not protrude beyond the portions of the nanofiber in which a non-nanoparticle component is at the surface (e.g., portions of the nanofiber surface in which a polymeric component is at the surface). In FIG. 4B, a nanofiber 402 comprises a nanoparticle 302 that is present at but does not protrude beyond the surface 502 thereof. In such embodiments, the external surface of the nanofiber may be substantially the same as the external surface of an otherwise equivalent nanofiber lacking the nanoparticle and/or may not include any protrusions or other features indicative of the presence of nanoparticles therein. In some embodiments, the presence of such nanoparticles are not observable by SEM. The presence of such nanoparticles may be observable by other techniques in some embodiments, such as by water contact angle (e.g., if the nanoparticle has a different surface energy than another component making up the surface of the nanofiber, such as a polymeric component). In some embodiments, a nanofiber comprises a nanoparticle that is located at a surface thereof and protrudes beyond the portions of the nanofiber in which a non-nanoparticle component is at the surface. FIG. 4C shows an example of this type of nanoparticle. In FIG. 4C, a nanoparticle 304 protrudes beyond a surface 504 of a nanofiber 404.

In some embodiments, a plurality of nanofibers comprises a plurality of nanoparticles, and at least a portion of the nanoparticles are at least partially embedded in a nanofiber. When a nanoparticle is partially embedded in a nanofiber, it is positioned with respect to the nanofiber such that it is partially surrounded by other components of the nanofiber. In other words, the nanoparticle that is partially embedded in a nanofiber is present at the surface of the nanofiber and comprises a portion that penetrates into the interior of the nanoparticle. By way of example, in FIG. 4B, the nanoparticle 302 is partially embedded in the nanofiber 402 because its upper portion penetrates into the interior the nanofiber 402 and its lower portion is present at the surface 502 of the nanoparticle 402. Similarly, in FIG. 4C, the nanoparticle 304 is partially embedded in the nanofiber 404 because its upper portion penetrates into the interior of the nanofiber 404 and its lower portion is present at the surface 504 of the nanoparticle 404 and protrudes beyond the surface 504 of the nanofiber 404. By contrast, the nanoparticle 306 in FIG. 4D is not embedded (partially or fully) in the nanofiber 406. While present at the surface, and perhaps maintained at the surface of the nanofiber by a resin coating the nanofiber and/or by other means, this nanoparticle does not penetrate into the interior of the nanofiber 406 (i.e., this nanoparticle does not penetrate into the interior of the material forming the nanofiber itself).

FIG. 4E shows one example of a nanoparticle 308 that is separate from a nanofiber 408. Here, the nanofiber and the nanoparticle are not in contact at all and the nanoparticle makes up no portion of the nanofiber. Such would be considered to be part of the filter media without being part of the nanofibers themselves. In other words, the plurality of nanofibers would not comprise such particles.

In some embodiments, a plurality of nanofibers comprises a plurality of nanoparticles, and the plurality of nanoparticles is distributed within the plurality of nanofibers in a particularly advantageous manner. For instance, the plurality of nanoparticles may be distributed within the plurality of nanofibers such that there is little or no aggregation of the nanoparticles in the nanofibers. In other embodiments, the nanoparticles may be aggregated to form clusters.

A variety of suitable types of nanoparticles may be employed in layers comprising nanofibers (e.g., nanoparticles at least partially embedded in the nanofibers therein). For instance, in some embodiments, the plurality of nanoparticles comprises inorganic nanoparticles. When present, the inorganic nanoparticles may comprise ceramic nanoparticles and/or metal nanoparticles. Non-limiting examples of suitable types of inorganic nanoparticles include silica nanoparticles (e.g., fumed silica nanoparticles), aluminosilicate nanoparticles, gold nanoparticles, copper nanoparticles, metal oxide nanoparticles, carbon nanoparticles, graphite nanoparticles, carbon nanotubes, chalcogenide nanoparticles (e.g., metal chalcogenide nanoparticles), clay nanoparticles, and/or quantum dots. In some embodiments, the plurality of nanoparticles comprises organic nanoparticles, such as polymer nanoparticles (e.g., nanocellulose nanoparticles). In some embodiments, the plurality of nanoparticles may comprise nanoparticles with one or more advantageous properties, such as magnetic nanoparticles, fluorescent nanoparticles, plasmonic nanoparticles, conductive nanoparticles, catalytic nanoparticles, biocidal nanoparticles, and the like. The nanoparticles are typically, but not always, uncharged. In some embodiments, the nanoparticles may be functionalized to aid compatibilization with one or more other components of the nanofiber (e.g., a polymeric component) as described above. This may desirably suppress aggregation of the nanoparticles therein.

It should be understood that when two or more layers comprise nanofibers, each layer comprising nanofibers may independently comprise nanoparticles of one or more of the types described above.

When present, the nanoparticles may have a variety of suitable average diameters. The average diameter of the nanoparticles may be greater than or equal to 2 nm, greater than or equal to 2.5 nm, greater than or equal to 3 nm, greater than or equal to 4 nm, greater than or equal to 5 nm, greater than or equal to 7.5 nm, greater than or equal to 10 nm, greater than or equal to 12.5 nm, greater than or equal to 15 nm, greater than or equal to 20 nm, greater than or equal to 25 nm, greater than or equal to 30 nm, greater than or equal to 40 nm, greater than or equal to 50 nm, or greater than or equal to 75 nm. The average diameter of the nanoparticles may be less than or equal to 100 nm, less than or equal to 75 nm, less than or equal to 50 nm, less than or equal to 40 nm, less than or equal to 30 nm, less than or equal to 25 nm, less than or equal to 20 nm, less than or equal to 15 nm, less than or equal to 12.5 nm, less than or equal to 10 nm, less than or equal to 7.5 nm, less than or equal to 5 nm, less than or equal to 4 nm, less than or equal to 3 nm, or less than or equal to 2.5 nm. Combinations of the above-referenced ranges are also possible (e.g., greater than or equal to 2 nm and less than or equal to 100 nm, greater than or equal to 5 nm and less than or equal to 50 nm, or greater than or equal to 10 nm and less than or equal to 40 nm). Other ranges are also possible. The average diameter of the nanoparticles may be determined by TEM. As used herein, the diameter of a nanoparticle is the diameter of a circle having an equivalent area to the area of the nanoparticle when measured by TEM. The average diameter of the nanoparticles is the average of the diameters of the nanoparticles in the plurality of nanoparticles.

It should be understood that when two or more layers comprise nanofibers, each layer comprising nanofibers may independently comprise nanoparticles having an average diameter in one or more of the ranges described above.

When a layer comprising nanofibers comprises a plurality of nanoparticles, the plurality of nanoparticles may make up any suitable wt % of the plurality thereof. In some embodiments, the plurality of nanoparticles makes up greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, or greater than or equal to 12.5 wt % of the layer comprising nanofibers. In some embodiments, the plurality of nanoparticles makes up less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, or less than or equal to 0.75 wt % of the layer comprising nanofibers. Combinations of the above-referenced ranges are also possible (e.g., greater than or equal to 0.5 wt % and less than or equal to 15 wt % of the plurality of nanofibers, greater than or equal to 1 wt % and less than or equal to 10 wt % plurality of nanofibers, or greater than or equal to 1 wt % and less than or equal to 5 wt % plurality of nanofibers). Other ranges are also possible.

It should be understood that when two or more layers comprise nanofibers, each layer comprising nanofibers may independently comprise nanoparticles in one or more of the amounts described above.

When present, a layer comprising nanofibers may have a variety of suitable solidities. In some embodiments, a layer comprising nanofibers has a solidity of greater than or equal to 1%, greater than or equal to 2%, greater than or equal to 5%, greater than or equal to 10%, greater than or equal to 15%, greater than or equal to 20%, greater than or equal to 30%, greater than or equal to 40%, or greater than or equal to 50%. In some embodiments, a layer comprising nanofibers has a solidity of less than or equal to 60%, less than or equal to 50%, less than or equal to 40%, less than or equal to 30%, less than or equal to 20%, less than or equal to 15%, less than or equal to 10%, less than or equal to 5%, or less than or equal to 2%. Combinations of the above-referenced ranges are also possible (e.g., greater than or equal to 1% and less than or equal to 60%, greater than or equal to 5% and less than or equal to 50%, or greater than or equal to 5% and less than or equal to 60%). Other ranges are also possible.

It should be understood that when two or more layers comprise nanofibers, each layer comprising nanofibers may independently have a solidity in one or more of the ranges described above.

The solidity of a layer is equivalent to the percentage of the interior of the layer occupied by solid material. One non-limiting way of determining solidity of a layer is described in this paragraph, but other methods are also possible. The method described in this paragraph includes determining the basis weight and thickness of the layer and then applying the following formula: solidity=[basis weight of the layer/(density of the components forming the layer*thickness of the layer)]*100%. The density of the components forming the layer is equivalent to the average density of the material or material(s) forming the components of the layer (e.g., fibers, particles, resin), which is typically specified by the manufacturer of each material. The average density of the materials forming the components of the layer may be determined by: (1) determining the total volume of all of the components in the layer; and (2) dividing the total mass of all of the components in the layer by the total volume of all of the components in the layer. If the mass and density of each component of the layer are known, the volume of all the components in the layer may be determined by: (1) for each type of component, dividing the total mass of the component in the layer by the density of the component; and (2) summing the volumes of each component. If the mass and density of each component of the layer are not known, the volume of all the components in the layer may be determined in accordance with Archimedes' principle.

When present, a layer comprising nanofibers may have a variety of suitable basis weights. In some embodiments, a layer comprising nanofibers has a basis weight of greater than or equal to 0.1 gsm, greater than or equal to 0.2 gsm, greater than or equal to 0.5 gsm, greater than or equal to 0.75 gsm, greater than or equal to 1 gsm, greater than or equal to 2 gsm, greater than or equal to 3 gsm, greater than or equal to 5 gsm, or greater than or equal to 7.5 gsm. In some embodiments, a layer comprising nanofibers has a basis weight of less than or equal to 10 gsm, less than or equal to 7.5 gsm, less than or equal to 5 gsm, less than or equal to 3 gsm, less than or equal to 2 gsm, less than or equal to 1 gsm, less than or equal to 0.75 gsm, less than or equal to 0.5 gsm, or less than or equal to 0.2 gsm. Combinations of the above-referenced ranges are also possible (e.g., greater than or equal to 0.1 gsm and less than or equal to 10 gsm). Other ranges are also possible.

It should be understood that when two or more layers comprise nanofibers, each layer comprising nanofibers may independently have a basis weight in one or more of the ranges described above.

When present, a layer comprising nanofibers may have a relatively high initial water contact angle. For instance, a layer comprising nanofibers may have an initial water contact angle of greater than or equal to 70°, greater than or equal to 80°, greater than or equal to 90°, greater than or equal to 100°, greater than or equal to 110°, greater than or equal to 120°, greater than or equal to 130°, greater than or equal to 140°, greater than or equal to 150°, greater than or equal to 160°, or greater than or equal to 170°. In some embodiments, a layer comprising nanofibers has an initial water contact angle of less than or equal to 180° less than or equal to 170°, less than or equal to 160°, less than or equal to 150°, less than or equal to 140°, less than or equal to 130°, less than or equal to 120°, less than or equal to 110°, less than or equal to 100°, less than or equal to 90°, or less than or equal to 80°. Combinations of the above-referenced ranges are also possible (e.g., greater than or equal to 700 and less than or equal to 180°, or greater than or equal to 900 and less than or equal to 180°). Other ranges are also possible. The initial water contact angle may be determined by following the procedure described in ASTM D5946 (2009) and measuring the contact angle within 15 seconds of water application.

It should be understood that when two or more layers comprise nanofibers, each layer comprising nanofibers may independently have an initial water contact angle in one or more of the ranges described above.

When present, a layer comprising nanofibers may have a relatively high elongation at break. For instance, a layer comprising nanofibers may have an elongation at break of greater than or equal to 50%, greater than or equal to 55%, greater than or equal to 60%, greater than or equal to 65%, greater than or equal to 70%, greater than or equal to 75%, greater than or equal to 80%, greater than or equal to 85%, or greater than or equal to 90%. In some embodiments, a layer comprising nanofibers has an elongation at break of less than or equal to 100%, less than or equal to 90%, less than or equal to 85%, less than or equal to 80%, less than or equal to 75%, less than or equal to 70%, less than or equal to 65%, less than or equal to 60%, or less than or equal to 55%. Combinations of the above-referenced ranges are also possible (e.g., greater than or equal to 50% and less than or equal to 100%, or greater than or equal to 60% and less than or equal to 100%). Other ranges are also possible. The elongation at break may be determined by performing a tensile test. Briefly, the following procedure may be followed: (1) A 1″ by 7″ sample of the layer comprising the nanofibers may be cut from the layer comprising the nanofibers; (2) The 1″ by 7″ sample may be loaded into a Thwing-Albert tensile tester equipped with a 20 N load cell and having a gap between the jaws of 3.5″; (3) The sample may be extended by the jaws at a rate of 12″ per minute until the sample breaks.

It should be understood that when two or more layers comprise nanofibers, each layer comprising nanofibers may independently have an elongation at break in one or more of the ranges described above.

When present, a layer comprising nanofibers may have a relatively low modulus. For instance, a layer comprising nanofibers may have a modulus of less than or equal to 150 g_{f}/gsm, less than or equal to 140 g_{f}/gsm, less than or equal to 130 g_{f}/gsm, less than or equal to 120 g_{f}/gsm, less than or equal to 110 g_{f}/gsm, less than or equal to 100 g_{f}/gsm, less than or equal to 90 g_{f}/gsm, less than or equal to 80 g_{f}/gsm, less than or equal to 70 g_{f}/gsm, less than or equal to 60 g_{f}/gsm, or less than or equal to 50 g_{f}/gsm. In some embodiments, a layer comprising nanofibers has a modulus of greater than or equal to 40 g_{f}/gsm, greater than or equal to 50 g_{f}/gsm, greater than or equal to 60 g_{f}/gsm, greater than or equal to 70 g_{f}/gsm, greater than or equal to 80 g_{f}/gsm, greater than or equal to 90 g_{f}/gsm, greater than or equal to 100 g_{f}/gsm, greater than or equal to 110 g_{f}/gsm, greater than or equal to 120 g_{f}/gsm, greater than or equal to 130 g_{f}/gsm, or greater than or equal to 140 g_{f}/gsm. Combinations of the above-referenced ranges are also possible (e.g., greater than or equal to 40 g_{f}/gsm and less than or equal to 150 g_{f}/gsm). Other ranges are also possible. As used herein, the modulus of a layer comprising nanofibers may be determined by: (1) Performing the measurement technique described above used to determine elongation at break; and (2) Dividing the stress at peak strain measured during this technique by the peak strain measured during this technique.

It should be understood that when two or more layers comprise nanofibers, each layer comprising nanofibers may independently have a modulus in one or more of the ranges described above.

When present, a layer comprising nanofibers may have a relatively high specific tensile strength. For instance, a layer comprising nanofibers may have a specific tensile strength of greater than or equal to 30 g_{f}/gsm, greater than or equal to 35 g_{f}/gsm, greater than or equal to 40 g_{f}/gsm, greater than or equal to 45 g_{f}/gsm, greater than or equal to 50 g_{f}/gsm, greater than or equal to 55 g_{f}/gsm, greater than or equal to 60 g_{f}/gsm, greater than or equal to 70 g_{f}/gsm, greater than or equal to 80 g_{f}/gsm, greater than or equal to 90 g_{f}/gsm, greater than or equal to 100 g_{f}/gsm, greater than or equal to 200 g_{f}/gsm, greater than or equal to 300 g_{f}/gsm, greater than or equal to 400 g_{f}/gsm, greater than or equal to 500 g_{f}/gsm, greater than or equal to 600 g_{f}/gsm, greater than or equal to 700 g_{f}/gsm, greater than or equal to 800 g_{f}/gsm, or greater than or equal to 900 g_{f}/gsm. In some embodiments, a layer comprising nanofibers has a specific tensile strength of less than or equal to 1000 g_{f}/gsm, less than or equal to 900 g_{f}/gsm, less than or equal to 800 g_{f}/gsm, less than or equal to 700 g_{f}/gsm, less than or equal to 600 g_{f}/gsm, less than or equal to 500 g_{f}/gsm, less than or equal to 400 g_{f}/gsm, less than or equal to 300 g_{f}/gsm, less than or equal to 200 gr/gsm, less than or equal to 100 gr/gsm, less than or equal to 90 gr/gsm, less than or equal to 80 g_{f}/gsm, less than or equal to 70 g_{f}/gsm, less than or equal to 60 g_{f}/gsm, less than or equal to 55 g_{f}/gsm, less than or equal to 50 g_{f}/gsm, less than or equal to 45 g_{f}/gsm, less than or equal to 40 g_{f}/gsm, or less than or equal to 35 g_{f}/gsm. Combinations of the above-referenced ranges are also possible (e.g., greater than or equal to 30 g_{f}/gsm and less than or equal to 1000 g_{f}/gsm, greater than or equal to 30 g_{f}/gsm and less than or equal to 100 g_{f}/gsm, or greater than or equal to 50 g_{f}/gsm and less than or equal to 100 g_{f}/gsm). Other ranges are also possible. The specific tensile strength may be determined by following the same procedure described above for determining the elongation at break but determining the tensile strength instead of the elongation at break and then dividing the elongation at break by the basis weight.

It should be understood that when two or more layers comprise nanofibers, each layer comprising nanofibers may independently have a specific tensile strength in one or more of the ranges described above.

When present, a layer comprising nanofibers may have a relatively low water wicking time. Without wishing to be bound by any particular theory, it is believed that low water wicking times may be desirable because they may allow the nanofiber layer to pass water therethrough relatively readily. In some embodiments, a layer comprising nanofibers has a water wicking time of less than or equal to 5 minutes, less than or equal to 4.5 minutes, less than or equal to 4 minutes, less than or equal to 3.5 minutes, less than or equal to 3 minutes, less than or equal to 2.5 minutes, less than or equal to 2 minutes, less than or equal to 1.5 minutes, or less than or equal to 1 minute. In some embodiments, a layer comprising nanofibers has a water wicking time of greater than or equal to 0.5 minutes, greater than or equal to 1 minute, greater than or equal to 1.5 minutes, greater than or equal to 2 minutes, greater than or equal to 2.5 minutes, greater than or equal to 3 minutes, greater than or equal to 3.5 minutes, greater than or equal to 4 minutes, or greater than or equal to 4.5 minutes. Combinations of the above-referenced ranges are also possible (e.g., less than or equal to 5 minutes and greater than or equal to 0.5 minutes, or less than or equal to 2 minutes and greater than or equal to 0.5 minutes). Other ranges are also possible. The water wicking time may be determined by placing a 4 microliter drop of deionized water on the layer comprising the nanofibers and determining the amount of time necessary for the water contact angle of the layer comprising the nanofibers to reach 20°.

It should be understood that when two or more layers comprise nanofibers, each layer comprising nanofibers may independently have a water wicking time in one or more of the ranges described above.

When present, a layer comprising nanofibers may have a variety of suitable mean flow pore sizes. In some embodiments, a layer comprising nanofibers has a mean flow pore size of greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, or greater than or equal to 12.5 microns. In some embodiments, a layer comprising nanofibers has a mean flow pore size of less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 15 microns). Other ranges are also possible. The mean flow pore size may be determined in accordance with ASTM F316 (2003).

It should be understood that when two or more layers comprise nanofibers, each layer comprising nanofibers may independently have a mean flow pore size in one or more of the ranges described above.

When present, a layer comprising nanofibers may have a variety of suitable air permeabilities. In some embodiments, a layer comprising nanofibers has an air permeability of greater than or equal to 0.5 CFM, greater than or equal to 1 CFM, greater than or equal to 2 CFM, greater than or equal to 5 CFM, greater than or equal to 10 CFM, greater than or equal to 20 CFM, greater than or equal to 30 CFM, greater than or equal to 40 CFM, greater than or equal to 50 CFM, or greater than or equal to 60 CFM. In some embodiments, a layer comprising nanofibers has an air permeability of less than or equal to 75 CFM, less than or equal to 60 CFM, less than or equal to 50 CFM, less than or equal to 40 CFM, less than or equal to 30 CFM, less than or equal to 20 CFM, less than or equal to 10 CFM, less than or equal to 5 CFM, less than or equal to 2 CFM, or less than or equal to 1 CFM. Combinations of the above-referenced ranges are also possible (e.g., greater than or equal to 0.5 CFM and less than or equal to 75 CFM). Other ranges are also possible. The air permeability may be determined in accordance with ASTM Test Standard D737-04 (2016) at a pressure of 125 Pa.

As described above, in some embodiments a filter media comprises one or more supplemental layers. In some embodiments, the one or more supplemental layers may comprise one or more backer layers. The backer layer(s) may support another layer present in the filter media (e.g., a layer comprising nanofibers) and/or may be a layer onto which another layer was deposited during fabrication of the filter media. For example, in some embodiments, a filter media may comprise a backer layer onto which a layer comprising nanofibers was deposited. The backer layer(s) may provide structural support and/or enhance the ease with which the filter media may be fabricated without appreciably increasing the resistance of the filter media. In some embodiments, the backer layer does not contribute appreciably to the filtration performance of the filter media. In other embodiments, the backer layer(s) may enhance the performance of the filter media in one or more ways (e.g., one or more backer layers may be positioned upstream of other layers and/or may serve as prefilter layers). In some embodiments, a filter media comprises two or more backer layers. For instance, a filter media may comprise two or more backer layers disposed on one another that together form a composite backer layer. In some embodiments, an adhesive may be disposed on the backer layer (e.g., positioned between the backer layer and a layer comprising nanofibers).

It should be understood that any individual backer layer (and/or composite backer layer) may independently have some or all of the properties described below with respect to backer layers. It should also be understood that a filter media may comprise two backer layers that are identical and/or may comprise two or more backer layers that differ in one or more ways.

As described above, in some embodiments a filter media comprises one or more supplemental layers other than backer layers. Such supplemental layers are referred to herein as “additional layers”. The additional layer(s) may be provided in addition to a layer comprising nanofibers (e.g., in combination with a backer layer). Non-limiting examples of suitable additional layers include prefilter layers and protective layers. In some embodiments, a filter media comprises an additional layer that is a scrim (e.g., a prefilter layer that is also a scrim, a protective layer that is also a scrim). The additional layer(s) may be attached to another layer in the fiber web (e.g., a layer comprising nanofibers, a backer layer, another additional layer) in a variety of suitable manners, such as with an adhesive, by use of a calender, and/or by ultrasonic bonding.

When present, an additional layer may have a wide variety of properties. In some embodiments, the additional layer does not contribute appreciably to the filtration performance of the filter media. In other embodiments, the additional layer does contribute to one or more properties of the filter media. For instance, the additional layer may serve as a prefilter layer. As another example, a relatively large percentage of the total pressure drop across the filter media may occur across the additional layer. This may be beneficial when one or more other layers in the filter media are relatively fragile and/or may not be able to withstand a large pressure drop.

It should be understood that any individual additional layer may independently have some or all of the properties described below with respect to additional layers. It should also be understood that a filter media may comprise two additional layers that are identical and/or may comprise two or more additional layers that differ in one or more ways.

When present, a supplemental layer (e.g., a backer layer, an additional layer) typically comprises a non-woven fiber web comprising a plurality of fibers. A variety of suitable types of non-woven fiber webs may be employed as supplemental layers in the filter media described herein. For instance, a filter media may comprise a supplemental layer comprising a wetlaid non-woven fiber web, a non-wetlaid non-woven fiber web (such as, e.g., a meltblown non-woven fiber web, a airlaid non-woven fiber web, a carded non-woven fiber web, a spunbond non-woven fiber web), an electrospun non-woven fiber web, a scrim, and/or another type of non-woven fiber web. In some embodiments, a filter media comprises a supplemental layer that is a paste-dot scrim. The paste-dot scrim may comprise a topological pattern (e.g., of dots having a cylindrical cross-section, of dots having a non-cylindrical cross-section) formed from an adhesive. The adhesive may be polymeric (e.g., it may comprise poly(ester)) and/or may have a relatively high glass transition temperature (e.g., of greater than 100° C.).

In embodiments in which more than one supplemental layer is present, each supplemental layer may independently be of one or more of the types described above.

In some embodiments, a supplemental layer (e.g., a backer layer, an additional layer) may be compressed. For instance, a filter media may comprise a supplemental layer that has been calendered, such as a calendered meltblown layer, a calendered carded layer, a calendered spunbond layer, and/or a calendered wetlaid layer. Calendering may involve, for example, compressing one or more layers using calender rolls under a particular linear pressure, temperature, and line speed. For instance, the linear pressure may be between 50 lb/inch and 400 lb/inch (e.g., between 200 lb/inch and 400 lb/inch, between 50 lb/inch and 200 lb/inch, or between 75 lb/inch and 300 lb/inch); the temperature may be between 75° F. and 400° F. (e.g., between 75° F. and 300° F., between 200° F. and 350° F., or between 275° F. and 390° F.); and the line speed may be between 5 ft/min and 100 ft/min (e.g., between 5 ft/min and 80 ft/min, between 10 ft/min and 50 ft/min, between 15 ft/min and 100 ft/min, or between 20 ft/min and 90 ft/min). Other ranges for linear pressure, temperature and line speed are also possible. In embodiments in which more than one supplemental layer is present, each supplemental layer may independently be compressed at a linear pressure, temperature, and/or line speed in one or more of the ranges described above.

When present, a supplemental layer (e.g., a backer layer, an additional layer) may comprise a plurality of fibers comprising a variety of suitable types of fibers. In some embodiments, a supplemental layer comprises a plurality of fibers comprising natural fibers (e.g., cellulose fibers). In some embodiments, a supplemental layer comprises a plurality of fibers comprising synthetic fibers and/or is made up of synthetic fibers (in other words, it may be a synthetic layer). The synthetic fibers, if present, may include monocomponent synthetic fibers and/or multicomponent synthetic fibers (e.g., bicomponent synthetic fibers). Non-limiting examples of suitable synthetic fibers include fibers comprising one or more of the following materials: poly(olefin)s (e.g., poly(propylene)), poly(ester)s (e.g., poly(butylene terephthalate), poly(ethylene terephthalate)), Nylons, poly(aramid)s, poly(vinyl alcohol), poly(ether sulfone), poly(acrylic)s (e.g., poly(acrylonitrile)), fluorinated polymers (e.g., poly(vinylidene difluoride)), and cellulose acetate. In some embodiments, a supplemental layer comprises a plurality of fibers comprising glass fibers. The supplemental layer may include more than one type of fiber (e.g., both glass fibers and synthetic fibers) or may include exclusively one type of fiber (e.g., exclusively synthetic fibers of multiple sub-types, such as both fibers comprising a poly(olefin) and fibers comprising a poly(ester); or exclusively fibers comprising poly(propylene)). In some embodiments, the plurality of fibers in the supplemental layer comprises fibers comprising a blend of two or more of the polymers listed above (e.g., a blend of a Nylon and a poly(ester)).

In embodiments in which more than one supplemental layer is present, each supplemental layer may independently comprise fibers comprising one or more of the types of fibers described above.

When a supplemental layer (e.g., a backer layer, an additional layer) comprises a plurality of fibers comprising cellulose fibers, the cellulose fibers therein may have a variety of suitable mean fiber widths. In some embodiments, a supplemental layer comprises cellulose fibers having a mean fiber width of greater than or equal to 5 microns, greater than or equal to 7 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a supplemental layer comprises cellulose fibers having a mean fiber width of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, or less than or equal to 7 microns. Combinations of the above-referenced ranges are also possible (e.g., greater than or equal to 5 microns and less than or equal to 50 microns, greater than or equal to 7 microns and less than or equal to 30 microns, or greater than or equal to 10 microns and less than or equal to 20 microns). Other ranges are also possible. The mean fiber width may be determined by scanning electron microscopy. As used herein, the mean fiber width refers to the average of the largest cross-sectional diameters of the fibers.

In embodiments in which a filter media comprises two or more supplemental layers comprising cellulose fibers, each supplemental layer comprising cellulose fibers may independently comprise cellulose fibers having a mean fiber width in one or more of the ranges described above.

When a supplemental layer (e.g., a backer layer, an additional layer) comprises a plurality of fibers comprising synthetic fibers, the synthetic fibers therein may have a variety of suitable mean fiber widths. In some embodiments, a supplemental layer comprises synthetic fibers having a mean fiber width of greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a supplemental layer comprises synthetic fibers having a mean fiber width of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, or less than or equal to 0.075 microns. Combinations of the above-referenced ranges are also possible (e.g., greater than or equal to 0.05 microns and less than or equal to 50 microns, greater than or equal to 0.05 microns and less than or equal to 30 microns, greater than or equal to 0.05 microns and less than or equal to 5 microns, greater than or equal to 0.05 microns and less than or equal to 2 microns, greater than or equal to 0.075 microns and less than or equal to 0.5 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. The mean fiber width may be determined by scanning electron microscopy. As used herein, the mean fiber width refers to the average of the largest cross-sectional diameters of the fibers.

In embodiments in which more than one supplemental layer comprising synthetic fibers is present, each supplemental layer comprising synthetic fibers may independently comprise synthetic fibers having a mean fiber width in one or more of the ranges described above.

When a supplemental layer (e.g., a backer layer, an additional layer) comprises a plurality of fibers comprising glass fibers, the glass fibers therein may have a variety of mean fiber widths. In some embodiments, a supplemental layer comprises glass fibers having a mean fiber width of greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, or greater than or equal to 12.5 microns. In some embodiments, a supplemental layer comprises glass fibers having a mean fiber width of less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, or less than or equal to 0.2 microns. Combinations of the above-referenced ranges are also possible (e.g., greater than or equal to 0.15 microns and less than or equal to 15 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. The mean fiber width may be determined by scanning electron microscopy. As used herein, the mean fiber width refers to the average of the largest cross-sectional diameters of the fibers.

In embodiments in which more than one supplemental layer comprising glass fibers is present, each supplemental layer comprising glass fibers may independently comprise glass fibers having a mean fiber width in one or more of the ranges described above.

The fibers in a plurality of fibers in a supplemental layer (e.g., a backer layer, an additional layer), if present, may have a variety of suitable average lengths. In some embodiments, the average length of the fibers in a supplemental layer is greater than or equal to 0.3 mm, greater than or equal to 0.4 mm, greater than or equal to 0.5 mm, greater than or equal to 0.75 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 7.5 mm, greater than or equal to 10 mm, greater than or equal to 12.5 mm, greater than or equal to 15 mm, greater than or equal to 20 mm, greater than or equal to 25 mm, greater than or equal to 30 mm, greater than or equal to 40 mm, greater than or equal to 50 mm, or greater than or equal to 75 mm. In some embodiments, the average length of the fibers in a supplemental layer is less than 100 mm, less than or equal to 75 mm, less than or equal to 50 mm, less than or equal to 40 mm, less than or equal to 30 mm, less than or equal to 25 mm, less than or equal to 20 mm, less than or equal to 15 mm, less than or equal to 12.5 mm, less than or equal to 10 mm, less than or equal to 7.5 mm, less than or equal to 5 mm, less than or equal to 4 mm, less than or equal to 3 mm, less than or equal to 2.5 mm, less than or equal to 2 mm, less than or equal to 1.5 mm, less than or equal to 1.25 mm, less than or equal to 1 mm, less than or equal to 0.75 mm, less than or equal to 0.5 mm, or less than or equal to 0.4 mm. Combinations of the above-referenced ranges are also possible (e.g., greater than or equal to 0.3 mm and less than 100 mm, or greater than or equal to 1 mm and less than or equal to 50 mm). Other ranges are also possible.

In embodiments in which more than one supplemental layer is present, each supplemental layer may independently comprise fibers having an average length in one or more of the ranges described above.

In some embodiments, a supplemental layer (e.g., a backer layer, an additional layer) comprises continuous fibers, which may have a variety of suitable lengths. For instance, the average length of the fibers in a supplemental layer may be greater than or equal to 100 mm, greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the average length of the fibers in a supplemental layer is less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 125 mm and less than or equal to 1 km, greater than or equal to 125 mm and less than or equal to 2 m). Other ranges are also possible.

In embodiments in which more than one supplemental layer is present, each supplemental layer may independently comprise fibers having an average length in one or more of the ranges described above.

Some supplemental layers (e.g., backer layers, additional layers) include components other than fibers. For instance, a supplemental layer may comprise a binder resin. The binder resin may make up less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, less than or equal to 0.75 wt %, less than or equal to 0.5 wt %, less than or equal to 0.4 wt %, less than or equal to 0.3 wt %, less than or equal to 0.25 wt %, less than or equal to 0.2 wt %, less than or equal to 0.15 wt %, less than or equal to 0.125 wt %, or less than or equal to 0.1 wt % of the supplemental layer. The binder resin may make up greater than or equal to 0 wt %, greater than or equal to 0.1 wt %, greater than or equal to 0.125 wt %, greater than or equal to 0.15 wt %, greater than or equal to 0.2 wt %, greater than or equal to 0.25 wt %, greater than or equal to 0.3 wt %, greater than or equal to 0.4 wt %, greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, or greater than or equal to 25 wt % of the supplemental layer. Combinations of the above-referenced ranges are also possible (e.g., less than or equal to 30 wt % of the supplemental layer). Other ranges are also possible. In some embodiments, the supplemental layer is binder-free (i.e., binder resin makes up 0 wt % of the supplemental layer).

In embodiments in which more than one supplemental layer is present, each supplemental layer may independently comprise a binder resin in an amount in one or more of the ranges described above.

When present, a supplemental layer (e.g., a backer layer, an additional layer) may have a variety of suitable solidities. In some embodiments, a supplemental layer has a solidity of greater than or equal to 4%, greater than or equal to 5%, greater than or equal to 7.5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 60%, greater than or equal to 70%, or greater than or equal to 80%. In some embodiments, a supplemental layer has a solidity of less than or equal to 50%, less than or equal to 90%, less than or equal to 80%, less than or equal to 70%, less than or equal to 60%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 7.5%, or less than or equal to 5%. Combinations of the above-referenced ranges are also possible (e.g., greater than or equal to 4% and less than or equal to 90%, greater than or equal to 4% and less than or equal to 50%, greater than or equal to 5% and less than or equal to 40%, or greater than or equal to 5% and less than or equal to 35%). Other ranges are also possible. Solidity may be measured as described elsewhere herein. In embodiments in which more than one supplemental layer is present, each supplemental layer may independently have a solidity in one or more of the ranges described above.

When present, a supplemental layer (e.g., a backer layer, an additional layer) may have a variety of suitable basis weights. In some embodiments, a supplemental layer has a basis weight of greater than or equal to 5 gsm, greater than or equal to 7.5 gsm, greater than or equal to 10 gsm, greater than or equal to 12.5 gsm, greater than or equal to 15 gsm, greater than or equal to 17.5 gsm, greater than or equal to 20 gsm, greater than or equal to 25 gsm, greater than or equal to 30 gsm, greater than or equal to 40 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, or greater than or equal to 400 gsm. In some embodiments, a supplemental layer has a basis weight of less than or equal to 500 gsm, less than or equal to 400 gsm, less than or equal to 300 gsm, less than or equal to 250 gsm, less than or equal to 200 gsm, less than or equal to 150 gsm, less than or equal to 100 gsm, less than or equal to 75 gsm, less than or equal to 50 gsm, less than or equal to 40 gsm, less than or equal to 30 gsm, less than or equal to 25 gsm, less than or equal to 20 gsm, less than or equal to 17.5 gsm, less than or equal to 15 gsm, less than or equal to 12.5 gsm, less than or equal to 10 gsm, or less than or equal to 7.5 gsm. Combinations of the above-referenced ranges are also possible (e.g., greater than or equal to 5 gsm and less than or equal to 500 gsm, greater than or equal to 15 gsm and less than or equal to 500 gsm, greater than or equal to 20 gsm and less than or equal to 300 gsm, or greater than or equal to 30 gsm and less than or equal to 200 gsm). Other ranges of basis weight are also possible. The basis weight of a supplemental layer may be determined in accordance with ISO 536:2012.

In embodiments in which more than one supplemental layer is present, each supplemental layer may independently have a basis weight in one or more of the ranges described above.

When present, a supplemental layer (e.g., a backer layer, an additional layer) may have a variety of suitable values of elongation at break. In some embodiments, a supplemental layer has an elongation at break of greater than or equal to 1%, greater than or equal to 2%, greater than or equal to 5%, greater than or equal to 7.5%, greater than or equal to 10%, greater than or equal to 15%, greater than or equal to 20%, greater than or equal to 25%, greater than or equal to 30%, or greater than or equal to 40%. In some embodiments, a supplemental layer has an elongation at break of less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, or less than or equal to 2%. Combinations of the above-referenced ranges are also possible (e.g., greater than or equal to 1% and less than or equal to 50%, greater than or equal to 1% and less than or equal to 10%, greater than or equal to 2% and less than or equal to 10%, or greater than or equal to 5% and less than or equal to 25%). Other ranges are also possible. The elongation at break of a supplemental layer may be determined in accordance with BCIS 03B (2018).

It should be understood that when two or more supplemental layers, each supplemental may independently have an elongation at break in one or more of the ranges described above.

When present, a supplemental layer (e.g., a backer layer, an additional layer) may have a variety of suitable specific surface areas. In some embodiments, a supplemental layer has a specific surface area of greater than 0 m²/g, greater than or equal to 0.1 m²/g, greater than or equal to 0.2 m²/g, greater than or equal to 0.5 m²/g, greater than or equal to 1 m²/g, greater than or equal to 2 m²/g, greater than or equal to 5 m²/g, greater than or equal to 10 m²/g, greater than or equal to 15 m²/g, greater than or equal to 20 m²/g, greater than or equal to 25 m²/g, greater than or equal to 30 m²/g, greater than or equal to 35 m²/g, greater than or equal to 40 m²/g, or greater than or equal to 45 m²/g. In some embodiments, a supplemental layer has a specific surface area of less than or equal to 50 m²/g, less than or equal to 45 m²/g, less than or equal to 40 m²/g, less than or equal to 35 m²/g, less than or equal to 30 m²/g, less than or equal to 25 m²/g, less than or equal to 20 m²/g, less than or equal to 15 m²/g, less than or equal to 10 m²/g, less than or equal to 5 m²/g, less than or equal to 2 m²/g, less than or equal to 1 m²/g, less than or equal to 0.5 m²/g, less than or equal to 0.2 m²/g, or less than or equal to 0.1 m²/g. Combinations of the above-referenced ranges are also possible (e.g., greater than 0 m²/g and less than or equal to 50 m²/g, greater than 0 m²/g and less than or equal to 40 m²/g, or greater than 0 m²/g and less than or equal to 35 m²/g). Other ranges are also possible. The specific surface area may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III2375 Surface Area Analyzer) with nitrogen gas; the sample amount is between 0.5 and 0.6 grams in a ¾″ tube; and, the sample is allowed to degas at 100° C. for a minimum of 3 hours.

In embodiments in which more than one supplemental layer is present, each supplemental layer may independently have a specific surface area in one or more of the ranges described above.

When present, a supplemental layer (e.g., a backer layer, an additional layer) may have a variety of suitable mean flow pore sizes. In some embodiments, a supplemental layer has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, or greater than or equal to 200 microns. In some embodiments, a supplemental layer has a mean flow pore size of less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 250 microns, greater than or equal to 0.1 micron and less than or equal to 50 microns, greater than or equal to 0.2 microns and less than or equal to 35 microns, or greater than or equal to 0.2 microns and less than or equal to 30 microns). Other ranges are also possible. The mean flow pore size of a supplemental layer may be determined in accordance with ASTM F316 (2003).

In embodiments in which more than one supplemental layer is present, each supplemental layer may independently have a mean flow pore size in one or more of the ranges described above.

When present, a supplemental layer (e.g., a backer layer, an additional layer) may have a variety of suitable maximum pore sizes. In some embodiments, a supplemental layer has a maximum pore size of greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, greater than or equal to 200 microns, greater than or equal to 250 microns, greater than or equal to 300 microns, greater than or equal to 400 microns, or greater than or equal to 500 microns. In some embodiments, a supplemental layer has a maximum pore size of less than or equal to 750 microns, less than or equal to 500 microns, less than or equal to 400 microns, less than or equal to 300 microns, less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, or less than or equal to 0.25 microns. Combinations of the above-referenced ranges are also possible (e.g., greater than or equal to 0.2 microns and less than or equal to 750 microns, greater than or equal to 0.2 microns and less than or equal to 50 microns, greater than or equal to 0.2 microns and less than or equal to 40 microns, or greater than or equal to 0.3 microns and less than or equal to 30 microns). Other ranges are also possible. The maximum pore size may be determined in accordance with ASTM F316 (2003).

In embodiments in which more than one supplemental layer is present, each supplemental layer may independently have a maximum pore size in one or more of the ranges described above.

When present, a supplemental layer (e.g., a backer layer, an additional layer) may have a variety of suitable ratios of maximum pore size to mean flow pore size. In some embodiments, a supplemental layer has a ratio of maximum pore size to mean flow pore size of greater than or equal to 1.3, greater than or equal to 1.5, greater than or equal to 1.75, greater than or equal to 2, greater than or equal to 2.5, greater than or equal to 3, greater than or equal to 4, greater than or equal to 5, greater than or equal to 7.5, greater than or equal to 10, greater than or equal to 12.5, greater than or equal to 15, greater than or equal to 20, or greater than or equal to 25. In some embodiments, a supplemental layer has a ratio of maximum pore size to mean flow pore size of less than or equal to 30, less than or equal to 25, less than or equal to 20, less than or equal to 15, less than or equal to 12.5, less than or equal to 10, less than or equal to 7.5, less than or equal to 5, less than or equal to 4, less than or equal to 3, less than or equal to 2.5, less than or equal to 2, less than or equal to 1.75, or less than or equal to 1.5. Combinations of the above-referenced ranges are also possible (e.g., greater than or equal to 1.3 and less than or equal to 30, greater than or equal to 1.3 and less than or equal to 25, or greater than or equal to 1.3 and less than or equal to 20). Other ranges are also possible. The ratio of maximum pore size to mean flow pore size may be determined by finding the maximum pore size and mean flow pore size in accordance with ASTM F316 (2003) and then dividing the maximum pore size by the mean flow pore size.

In embodiments in which more than one supplemental layer is present, each supplemental layer may independently have a ratio of maximum pore size to mean flow pore size in one or more of the ranges described above.

When present, a supplemental layer (e.g., a backer layer, an additional layer) may have a variety of suitable air permeabilities. In some embodiments, a supplemental layer has an air permeability of greater than or equal to 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, greater than or equal to 75 CFM, greater than or equal to 100 CFM, greater than or equal to 125 CFM, greater than or equal to 150 CFM, greater than or equal to 200 CFM, greater than or equal to 250 CFM, greater than or equal to 300 CFM, greater than or equal to 400 CFM, greater than or equal to 500 CFM, greater than or equal to 750 CFM, greater than or equal to 1000 CFM, greater than or equal to 1250 CFM, greater than or equal to 1500 CFM, greater than or equal to 2000 CFM, greater than or equal to 2500 CFM, greater than or equal to 3000 CFM, or greater than or equal to 5000 CFM. In some embodiments, a supplemental layer has an air permeability of less than or equal to 8000 CFM, less than or equal to 5000 CFM, less than or equal to 3000 CFM, less than or equal to 2500 CFM, less than or equal to 2000 CFM, less than or equal to 1500 CFM, less than or equal to 1250 CFM, less than or equal to 1000 CFM, less than or equal to 750 CFM, less than or equal to 500 CFM, less than or equal to 400 CFM, less than or equal to 300 CFM, less than or equal to 250 CFM, less than or equal to 200 CFM, less than or equal to 150 CFM, less than or equal to 125 CFM, less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 8000 CFM, greater than or equal to 0.5 CFM and less than or equal to 2000 CFM, greater than or equal to 0.5 CFM and less than or equal to 400 CFM, greater than or equal to 0.5 CFM and less than or equal to 200 CFM, greater than or equal to 1 CFM and less than or equal to 150 CFM, or greater than or equal to 1 CFM and less than or equal to 100 CFM). Other ranges are also possible. The air permeability may be determined in accordance with ASTM Test Standard D737-04 (2016) at a pressure of 125 Pa.

In embodiments in which more than one supplemental layer is present, each supplemental layer may independently have an air permeability in one or more of the ranges described above.

In some embodiments, a filter media comprises an adhesive positioned between two or more layers (e.g., between a layer comprising nanofibers and a supplemental layer, between two supplemental layers). As also described above, some filter media described herein comprise adhesive positioned between two or more pairs of layers (e.g., between a layer comprising nanofibers and a supplemental layer and between two supplemental layers, between two pairs of supplemental layers). It should be understood that an adhesive positioned between any specific pair of layers may have some or all of the properties described below with respect to adhesives. It should also be understood that a filter media may comprise two locations at which adhesive is positioned for which the adhesive has identical properties and/or may comprise two or more locations at which adhesive is positioned for which the adhesive differs in one or more ways.

In some embodiments, a filter media comprises an adhesive that is a solvent-based adhesive resin. As used herein, a solvent-based adhesive resin is an adhesive that is capable of undergoing a liquid to solid transition upon the evaporation of a solvent from the resin. Solvent-based adhesive resins may be applied while in the liquid state. Subsequently, the solvent that is present may evaporate to yield a solid adhesive. Solvent-based adhesives may thus be considered to be distinct from hot melt adhesives, which do not comprise volatile solvents (e.g., solvents that evaporate under normal operating conditions) and which typically undergo a liquid to solid transition as the adhesive cools.

In embodiments in which adhesive is present at more than one location, each location at which adhesive is present may independently comprise an adhesive that is a solvent-based adhesive resin.

Desirable properties for adhesives may include sufficient tackiness and open time (i.e., the amount of time that the adhesive remains tacky after being exposed to the ambient atmosphere). Without wishing to be bound by theory, the tackiness of an adhesive may depend on both the glass transition temperature of the adhesive and the molecular weight of any polymeric components of the adhesive. Higher values of glass transition and lower values of molecular weight may promote enhanced tackiness, and higher values of molecular weight may result in higher cohesion in the adhesive and higher bond strength. In some embodiments, adhesives having a glass transition temperature and/or molecular weight in one or more ranges described herein may provide appropriate values of both tackiness and open time. For example, the adhesive may be configured to remain tacky for a relatively long time (e.g., the adhesive may remain tacky after full evaporation of any solvents initially present, and/or may be tacky indefinitely when held at room temperature). In some embodiments, the open time of the adhesive may be less than or equal to 24 hours, less than or equal to 12 hours, less than or equal to 6 hours, less than or equal to 1 hour, less than or equal to 30 minutes, less than or equal to 15 minutes, less than or equal to 10 minutes, less than or equal to 5 minutes, less than or equal to 3 minutes, less than or equal to 1 minute, less than or equal to 30 seconds, or less than or equal to 10 seconds. In some embodiments, the open time of the adhesive may be at least 1 second, at least 10 seconds, at least 15 seconds, at least 30 seconds, at least 1 minute, at least 3 minutes, at least 5 minutes, at least 10 minutes, at least 15 minutes, at least 30 minutes, at least 1 hour, at least 6 hours, or at least 12 hours. Combinations of the above-referenced ranges are also possible (e.g., at least 1 second and less than or equal to 24 hours). Other values are also possible.

In embodiments in which adhesive is present at more than one location, each location at which adhesive is present may independently comprise an adhesive having an open time in one or more of the ranges described above.

Non-limiting examples of suitable adhesives include adhesives comprising acrylates, acrylate copolymers, poly(urethane)s, poly(ester)s, poly(vinyl alcohol), ethylene-vinyl acetate copolymers, silicone solvents, poly(olefin)s, synthetic and/or natural rubber, synthetic elastomers, ethylene-acrylic acid copolymers, ethylene-methacrylate copolymers, ethylene-methyl methacrylate copolymers, poly(vinylidene chloride), poly(amide)s, epoxies, melamine resins, poly(isobutylene), styrenic block copolymers, styrene-butadiene rubber, aliphatic urethane acrylates, and/or phenolics.

In embodiments in which adhesive is present at more than one location, each location at which adhesive is present may independently comprise an adhesive comprising one or more of the materials described above.

When present, an adhesive may comprise a crosslinker and/or may be crosslinked. In some embodiments, the crosslinker is a small molecule as described above and/or the crosslink is a reaction product of a small molecule crosslinker as described above. In some embodiments, an adhesive comprises a small molecule crosslinker (and/or a reaction product thereof) that is one or more of a carbodiimide, an isocyanate, an aziridine, a zirconium compound such as zirconium carbonate, a metal acid ester, a metal chelate, a multifunctional propylene imine, and an amino resin. In some embodiments, the adhesive comprises at least one polymer and/or prepolymer with one or more reactive functional groups that are capable of reacting with the crosslinker and/or comprises a reaction product of one or more reactive functional groups on a polymer and/or prepolymer that have reacted with the crosslinker. Non-limiting examples of suitable reactive functional groups include alcohol groups, carboxylic acid groups, epoxy groups, amine groups, and amino groups. In some embodiments, a filter media comprises an adhesive that comprises one or more polymers and/or prepolymers that may undergo self-crosslinking via functional groups attached thereto. In some embodiments, a filter media comprises an adhesive that comprises a self-crosslinked reaction product of one or more polymers and/or prepolymers.

In embodiments in which adhesive is present at more than one location, each location at which adhesive is present may independently comprise an adhesive comprising one or more of the materials described above.

When present, a small molecule crosslinker and/or crosslinks that are reaction products thereof may make up any suitable amount of an adhesive. In some embodiments, the wt % of the crosslinker and/or crosslinks that are reaction products thereof is greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, or greater than or equal to 25 wt % with respect to the total mass of the adhesive. In some embodiments, the wt % of the small molecule crosslinker and/or crosslinks that are reaction products thereof is less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % with respect to the total mass of the adhesive. Combinations of the above-referenced ranges are also possible (e.g., greater than or equal to 0.1 wt % and less than or equal to 30 wt %, or greater than or equal to 1 wt % and less than or equal to 20 wt %). Other ranges are also possible.

In embodiments in which adhesive is present at more than one location, each location at which adhesive is present may independently comprise an adhesive comprising a small molecule crosslinker and/or crosslinks that are reaction products thereof in one or more of the amounts described above.

The adhesive and/or any small molecule crosslinkers therein may be capable of undergoing a crosslinking reaction at any suitable temperature and/or may have undergone a crosslinking reaction at any suitable temperature. In some embodiments, an adhesive may be capable of undergoing a cross-linking reaction and/or may have undergone a crosslinking reaction at a temperature of greater than or equal to 24° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., or greater than or equal to 140° C. In some embodiments, an adhesive may be capable of undergoing a cross-linking reaction and/or may have undergone a crosslinking reaction at a temperature of less than or equal to 150° C., less than or equal to 140° C., less than or equal to 130° C., less than or equal to 120° C., less than or equal to 110° C., less than or equal to 100° C., less than or equal to 90° C., less than or equal to 80° C., less than or equal to 70° C., less than or equal to 60° C., less than or equal to 50° C., or less than or equal to 40° C. Combinations of the above-referenced ranges are also possible (e.g., greater than or equal to 25° C. and less than or equal to 150° C., or greater than or equal to 25° C. and less than or equal to 130° C.). Other ranges are also possible.

In embodiments in which adhesive is present at more than one location, each location at which adhesive is present may independently comprise an adhesive capable of undergoing a crosslinking reaction and/or may have undergone a crosslinking reaction at a temperature in one or more of the ranges described above.

When present, an adhesive may comprise a solvent and/or may be formed from a composition comprising a solvent (e.g., from which the solvent has evaporated). By way of example, some embodiments relate to an adhesive applied to the layer or filter media while dissolved or suspended in a solvent. Non-limiting examples of suitable solvents include water, hydrocarbon solvents, ketones, aromatic solvents, fluorinated solvents, toluene, heptane, acetone, n-butyl acetate, methyl ethyl ketone, methylene chloride, naphtha, and mineral spirits.

In embodiments in which adhesive is present at more than one location, each location at which adhesive is present may independently comprise one or more of the solvents described above and/or may be formed from a composition comprising one or more of the solvents described above.

When present, an adhesive may have a relatively low glass transition temperature. In some embodiments, an adhesive has a glass transition temperature of less than or equal to 60° C., less than or equal to 50° C., less than or equal to 45° C., less than or equal to 40° C., less than or equal to 35° C., less than or equal to 30° C., less than or equal to 25° C., less than or equal to 24° C., less than or equal to 20° C., less than or equal to 15° C., less than or equal to 10° C., less than or equal to 5° C., less than or equal to 0° C., less than or equal to −5° C., less than or equal to −10° C., less than or equal to −20° C., less than or equal to −30° C., less than or equal to −40° C., less than or equal to −50° C., less than or equal to −60° C., less than or equal to −70° C., less than or equal to −80° C., less than or equal to −90° C., less than or equal to −100° C., or less than or equal to −110° C. In some embodiments, an adhesive has a glass transition temperature of greater than or equal to −125° C., greater than or equal to −110° C., greater than or equal to −100° C., greater than or equal to −90° C., greater than or equal to −80° C., greater than or equal to −70° C., greater than or equal to −60° C., greater than or equal to −50° C., greater than or equal to −40° C., greater than or equal to −30° C., greater than or equal to −20° C., greater than or equal to −10° C., greater than or equal to 0° C., greater than or equal to 5° C., greater than or equal to 10° C., greater than or equal to 24° C., greater than or equal to 25° C., greater than or equal to 40° C., or greater than or equal to 50° C. Combinations of the above-referenced ranges are also possible (e.g., greater than or equal to −125° C. and less than or equal to 60° C., or greater than or equal to −100° C. and less than or equal to 25° C.). Other ranges are also possible. The value of the glass transition temperature for an adhesive may be measured by differential scanning calorimetry as described above.

In embodiments in which adhesive is present at more than one location, each location at which adhesive is present may independently comprise an adhesive having a glass transition temperature in one or more of the ranges described above.

When present, an adhesive may have a variety of suitable molecular weights. In some embodiments, an adhesive has a number average molecular weight of greater than or equal to 10 kDa, greater than or equal to 30 kDa, greater than or equal to 50 kDa, greater than or equal to 100 kDa, greater than or equal to 300 kDa, greater than or equal to 500 kDa, greater than or equal to 1000 kDa, greater than or equal to 2000 kDa, or greater than or equal to 3000 kDa. In some embodiments, an adhesive has a number average molecular weight of less than or equal to 5000 kDa, less than or equal to 4000 kDa, less than or equal to 3000 kDa, less than or equal to 1000 kDa, less than or equal to 500 kDa, less than or equal to 300 kDa, less than or equal to 100 kDa, less than or equal to 50 kDa, or less than or equal to 30 kDa. Combinations of the above-referenced ranges are also possible (e.g., greater than or equal to 10 kDa and less than or equal to 5000 kDa, or greater than or equal to 30 kDa and less than or equal to 3000 kDa). Other ranges are also possible. The number average molecular weight may be measured by light scattering.

In embodiments in which adhesive is present at more than one location, each location at which adhesive is present may independently comprise an adhesive having a molecular weight in one or more of the ranges described above.

When present, an adhesive may have a variety of suitable basis weights. In some embodiments, an adhesive has a basis weight of greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, an adhesive has a basis weight of less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

In embodiments in which adhesive is present at more than one location, each location at which adhesive is present may independently comprise an adhesive having a basis weight in one or more of the ranges described above.

In embodiments where the filter media comprises one or more adhesives, the total basis weight of the adhesives in the filter media together (i.e., the sum of the basis weights of the adhesive at each location) may be greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, the total basis weight of the adhesives in the filter media together may be less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

When present, an adhesive may adhere together two or more layers between which it is positioned. The strength of adhesion between the two layers may be relatively high. For instance, an adhesive may adhere two layers together with a bond strength of greater than or equal to 100 g/in², greater than or equal to 150 g/in², greater than or equal to 200 g/in², greater than or equal to 500 g/in², greater than or equal to 750 g/in², greater than or equal to 1000 g/in², greater than or equal to 1250 g/in², greater than or equal to 1500 g/in², greater than or equal to 1750 g/in², greater than or equal to 2000 g/in², greater than or equal to 2250 g/in², greater than or equal to 2500 g/in², greater than or equal to 2750 g/in², greater than or equal to 3000 g/in², greater than or equal to 3250 g/in², greater than or equal to 3500 g/in², greater than or equal to 3750 g/in², greater than or equal to 4000 g/in², greater than or equal to 4250 g/in², greater than or equal to 4500 g/in², or greater than or equal to 4750 g/in². In some embodiments, an adhesive adheres two layers together with a bond strength of less than or equal to 5000 g/in², less than or equal to 4750 g/in², less than or equal to 4500 g/in², less than or equal to 4250 g/in², less than or equal to 4000 g/in², less than or equal to 3750 g/in², less than or equal to 3500 g/in², less than or equal to 3250 g/in², less than or equal to 3000 g/in², less than or equal to 2750 g/in², less than or equal to 2500 g/in², less than or equal to 2250 g/in², less than or equal to 2000 g/in², less than or equal to 1750 g/in², less than or equal to 1500 g/in², less than or equal to 1250 g/in², less than or equal to 1000 g/in², less than or equal to 750 g/in², less than or equal to 500 g/in², less than or equal to 200 g/in², or less than or equal to 150 g/in². Combinations of the above-referenced ranges are also possible (e.g., greater than or equal to 100 g/in² and less than or equal to 5000 g/in², or greater than or equal to 150 g/in² and less than or equal to 3000 g/in²). Other ranges are also possible.

In embodiments in which adhesive is present at more than one location, each location at which adhesive is present may independently comprise an adhesive adhering together two layers with a bond strength in one or more of the ranges described above. In some embodiments, the entire filter media as a whole has an internal bond strength in one or more ranges described above. The bond strength of the entire filter media as a whole is equivalent to the weakest bond strength between two layers of the media.

The bond strength (e.g., internal bond strength) between two layers (e.g., between two layers adhered together by an adhesive) may be determined by using a z-directional peel strength test. In short, the bond strength may be determined by the following procedure. First, a 1″×1″ sample may be mounted on a steel block with dimensions 1″×1″×0.5″ using double sided tape. The sample block may then be mounted onto the non-traversing head of a tensile tester and another steel block of the same size may be connected to the traversing head with double sided tape. The traversing head may brought down and bonded to the sample on the steel block of the non-traversing head. Enough pressure may be applied so that the steel blocks are bonded together via the mounted sample. The traversing head may then be moved at a traversing speed of 1″/min and the maximum load is found from the peak of a stress-strain curve. The bond strength (e.g., internal bond strength) between the two layers is considered to be equivalent to the maximum load measured by this procedure.

In some embodiments, a filter media described herein has a relatively high value of gamma at the most penetrating particle size (MPPS) and/or a relatively low value of penetration at the MPPS. Gamma is defined by the following formula: Gamma=(−log₁₀(MPPS penetration %/100)/(average pressure drop, mm H₂O)×100. Penetration, often expressed as a percentage, is defined as follows: Pen (%)=(C/C₀)*100 where C is the particle concentration after passage through the filter and C₀ is the particle concentration before passage through the filter. MPPS penetration is the penetration of the most penetrating particle size; in other words, when penetration is measured for a range of particle sizes, the MPPS penetration is the value of penetration measured for the particle with the highest penetration.

MPPS penetration and average pressure drop can be measured using the EN1822:2009 standard for air filtration, which is described below. Penetration and average pressure drop may be measured by blowing dioctyl phthalate (DOP) particles through a filter media and measuring the percentage of particles that penetrate therethrough and the pressure drop as the particles are blown through the filter media. This may be accomplished by use of a TSI 3160 automated filter testing unit from TSI, Inc. equipped with a dioctyl phthalate generator for DOP aerosol testing based on the EN1822:2009 standard for MPPS DOP particles. The TSI 3160 automated filter testing unit may be employed to sequentially blow populations of DOP particles with varying average particle diameters at a 100 cm² face area of the upstream face of the filter media. The populations of particles may be blown at the upstream face of the filter media in order of increasing average diameter, may each have a geometric standard deviation of less than 1.3, and may have the following set of average diameters: 0.04 microns, 0.08 microns, 0.12 microns, 0.16 microns, 0.2 microns, 0.26 microns, and 0.3 microns. The penetration and average pressure drop may be measured continuously and separately for each population of particles over the period of time during which that population of particles is blown at the upstream face of the filter media. The upstream and downstream particle concentrations may be measured by use of condensation particle counters. During the penetration measurement, the 100 cm² face area of the upstream face of the filter media may be subject to a continuous loading of DOP particles at an airflow of 12 L/min, giving a media face velocity of 2 cm/s. Each population of particles may be blown at the upstream face of the filter media for 120 s or such that at least 1000 particles are counted downstream of the filter media, whichever is longer.

In some embodiments, a filter media has a gamma at the MPPS of greater than or equal to 4, greater than or equal to 5, greater than or equal to 6, greater than or equal to 8, greater than or equal to 10, greater than or equal to 12, greater than or equal to 15, greater than or equal to 17, greater than or equal to 20, greater than or equal to 25, greater than or equal to 30, greater than or equal to 35, greater than or equal to 40, greater than or equal to 50, greater than or equal to 55, greater than or equal to 60, greater than or equal to 65, greater than or equal to 70, greater than or equal to 75, or greater than or equal to 80. In some embodiments, a filter media has a gamma at the MPPS of less than or equal to 85, less than or equal to 80, less than or equal to 75, less than or equal to 70, less than or equal to 65, less than or equal to 60, less than or equal to 55, less than or equal to 50, less than or equal to 45, less than or equal to 40, less than or equal to 35, less than or equal to 30, less than or equal to 25, less than or equal to 20, less than or equal to 15, less than or equal to 10, less than or equal to 8, less than or equal to 6, or less than or equal to 5. Combinations of the above-referenced ranges are also possible (e.g., greater than or equal to 4 and less than or equal to 85, greater than or equal to 4 and less than or equal to 70, greater than or equal to 10 and less than or equal to 55, or greater than or equal to 30 and less than or equal to 55). Other ranges are also possible.

In some embodiments, a filter media has a penetration at the MPPS of less than or equal to 1%, less than or equal to 0.75%, less than or equal to 0.5%, less than or equal to 0.2%, less than or equal to 0.1%, less than or equal to 0.075%, less than or equal to 0.05%, or less than or equal to 0.02%. In some embodiments, a filter media has a penetration at the MPPS of greater than or equal to 0.01%, greater than or equal to 0.02%, greater than or equal to 0.05%, greater than or equal to 0.075%, greater than or equal to 0.1%, greater than or equal to 0.2%, greater than or equal to 0.5%, or greater than or equal to 0.75%. Combinations of the above-referenced ranges are also possible (e.g., less than or equal to 1% and greater than or equal to 0.01%, or less than or equal to 0.1% and greater than or equal to 0.01%). Other ranges are also possible.

In some embodiments, a filter media has a relatively low penetration at 0.2 microns. The penetration at 0.2 microns is the penetration as described above for 0.2 micron particles. This penetration value may be measured by following the procedure described above for measuring the penetration at the MPPS with the following modifications: (1) Only DOP particles having an average diameter of 0.2 microns are blown at the filter media; and (2) The DOP particles having an average diameter of 0.2 microns are blown at the filter media at a face velocity of 5.33 cm/s. The average pressure drop during this measurement may also be measured and may be referred to elsewhere herein as the “air resistance” of the filter media.

In some embodiments, a filter media has a penetration at 0.2 microns of less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 2%, less than or equal to 1%, less than or equal to 0.5%, or less than or equal to 0.2%. In some embodiments, a filter media has a penetration at 0.2 microns of greater than or equal to 0.1%, greater than or equal to 0.2%, greater than or equal to 0.5%, greater than or equal to 1%, greater than or equal to 2%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, or greater than or equal to 55%. Combinations of the above-referenced ranges are also possible (e.g., less than or equal to 60% and greater than or equal to 0.1%, or less than or equal to 40% and greater than or equal to 0.1%). Other ranges are also possible.

In some embodiments, a filter media has an air resistance of less than or equal to 30 mm H₂O, less than or equal to 25 mm H₂O, less than or equal to 20 mm H₂O, less than or equal to 15 mm H₂O, less than or equal to 12.5 mm H₂O, less than or equal to 10 mm H₂O, less than or equal to 7.5 mm H₂O, less than or equal to 5 mm H₂O, less than or equal to 2 mm H₂O, less than or equal to 1 mm H₂O, or less than or equal to 0.75 mm H₂O. In some embodiments, a filter media has an air resistance of greater than or equal to 0.5 mm H₂O, greater than or equal to 0.75 mm H₂O, greater than or equal to 1 mm H₂O, greater than or equal to 2 mm H₂O, greater than or equal to 5 mm H₂O, greater than or equal to 7.5 mm H₂O, greater than or equal to 10 mm H₂O, greater than or equal to 12.5 mm H₂O, greater than or equal to 15 mm H₂O, greater than or equal to 20 mm H₂O, or greater than or equal to 25 mm H₂O. Combinations of the above-referenced ranges are also possible (e.g., less than or equal to 30 mm H₂O and greater than or equal to 0.5 mm H₂O, less than or equal to 15 mm H₂O and greater than or equal to 0.5 mm H₂O, or less than or equal to 10 mm H₂O and greater than or equal to 0.5 mm H₂O). Other ranges are also possible.

In some embodiments, a filter media is a high efficiency particulate air (HEPA) or ultra-low particulate air (ULPA) filter. These filters are required to remove particulates at an efficiency level specified by EN1822:2009. In some embodiments, the filter media removes particulates at an efficiency of greater than 99.95% (H 13), greater than 99.995% (H 14), greater than 99.9995% (U 15), greater than 99.99995% (U 16), or greater than 99.999995% (U 17).

In some embodiments, a filter media, such as a filter media suitable for air filtration, has a relatively high dust holding capacity. In some embodiments, a filter media has a dust holding capacity of greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 75 gsm, greater than or equal to 100 gsm, greater than or equal to 125 gsm, greater than or equal to 150 gsm, greater than or equal to 200 gsm, or greater than or equal to 250 gsm. In some embodiments, a filter media has a dust holding capacity of less than or equal to 300 gsm, less than or equal to 250 gsm, less than or equal to 200 gsm, less than or equal to 150 gsm, less than or equal to 125 gsm, less than or equal to 100 gsm, less than or equal to 75 gsm, less than or equal to 60 gsm, less than or equal to 50 gsm, less than or equal to 40 gsm, or less than or equal to 30 gsm. Combinations of the above-referenced ranges are also possible (e.g., greater than or equal to 20 gsm and less than or equal to 300 gsm, or greater than or equal to 60 gsm and less than or equal to 200 gsm). Other ranges are also possible. The dust holding capacity is the difference in the weight of the filter media before exposure to a certain amount of fine dust and the weight of the filter media after the exposure to the fine dust, upon reaching a particular pressure drop across the filter media, divided by the area of the filter media. Dust holding capacity may be determined in accordance with ISO 19438 (2003) using ISO medium test dust (A3).

In some embodiments, a filter media, such as a filter media suitable for air filtration, has a relatively high specific dust holding capacity (which is equivalent to the dust holding capacity divided by the thickness). In some embodiments, a filter media has a specific dust holding capacity of greater than or equal to 50 gsm/mm, greater than or equal to 75 gsm/mm, greater than or equal to 100 gsm/mm, greater than or equal to 125 gsm/mm, greater than or equal to 150 gsm/mm, greater than or equal to 175 gsm/mm, greater than or equal to 200 gsm/mm, greater than or equal to 225 gsm/mm, greater than or equal to 250 gsm/mm, or greater than or equal to 275 gsm/mm. The filter media may have a specific dust holding capacity of less than or equal to 300 gsm/mm, less than or equal to 275 gsm/mm, less than or equal to 250 gsm/mm, less than or equal to 225 gsm/mm, less than or equal to 200 gsm/mm, less than or equal to 175 gsm/mm, less than or equal to 150 gsm/mm, less than or equal to 125 gsm/mm, less than or equal to 100 gsm/mm, or less than or equal to 75 gsm/mm. Combinations of the above-referenced ranges are also possible (e.g., greater than or equal to 50 gsm/mm and less than or equal to 300 gsm/mm, or greater than or equal to 100 gsm/mm and less than or equal to 200 gsm/mm). Other ranges are also possible.

In some embodiments, a filter media, such as a filter media suitable for fuel filtration, has a relatively high initial efficiency at 4 microns. The filter media may have an initial efficiency at 4 microns of greater than or equal to 75%, greater than or equal to 80%, greater than or equal to 85%, greater than or equal to 90%, greater than or equal to 95%, greater than or equal to 99%, or greater than or equal to 99.9%. The filter media may have an initial efficiency at 4 microns of less than or equal to 99.99%, less than or equal to 99.9%, less than or equal to 99%, less than or equal to 95%, less than or equal to 90%, less than or equal to 85%, or less than or equal to 80%. Combinations of the above-referenced ranges are also possible (e.g., greater than or equal to 75% and less than or equal to 99.99%, greater than or equal to 80% and less than or equal to 99.99%, or greater than or equal to 90% and less than or equal to 99.99%). Other ranges are also possible. The initial efficiency at 4 microns of a filter media may be determined in accordance with ISO 19438 (2003) using ISO medium test dust (A3), where the initial efficiency at 4 microns is the efficiency at 4 microns measured when the pressure drop reaches 5 kPa (5% of the terminal value of 100 kPa).

In some embodiments, a filter media, such as a filter media suitable for fuel filtration, has a relatively high initial efficiency at 1.5 microns. The filter media may have an initial efficiency at 1.5 microns of greater than or equal to 60%, greater than or equal to 70%, greater than or equal to 75%, greater than or equal to 85%, greater than or equal to 90%, greater than or equal to 95%, greater than or equal to 99%, or greater than or equal to 99.9%. The filter media may have an initial efficiency at 1.5 microns of less than or equal to 99.99%, less than or equal to 99.9%, less than or equal to 99%, less than or equal to 95%, less than or equal to 90%, less than or equal to 85%, less than or equal to 80%, less than or equal to 75%, or less than or equal to 70%. Combinations of the above-referenced ranges are also possible (e.g., greater than or equal to 60% and less than or equal to 99.99%, greater than or equal to 70% and less than or equal to 99.99%, or greater than or equal to 90% and less than or equal to 99.99%). Other ranges are also possible. The initial efficiency at 1.5 microns of a filter media may be determined in accordance with ISO 19438 (2003) using ISO fine test dust (A2), where the initial efficiency at 1.5 microns is the efficiency at 1.5 microns measured when the pressure drop reaches 5 kPa (5% of the terminal value of 100 kPa).

In some embodiments, a filter media, such as a filter media suitable for hydraulic filtration and/or a filter media suitable for fuel filtration, has a relatively low micron rating for a beta 200 efficiency. A filter media has a micron rating or x for a certain beta efficiency (e.g., beta 200) when the filter media has that efficiency (e.g., beta 200=99.5% efficiency) for trapping x micron or larger particles. Generally, a lower micron rating means that the media or layer is able to trap smaller particles or is more “efficient” than a media or layer having a relatively larger micron rating. In some embodiments, a filter media has a micron rating for a beta 200 efficiency of less than or equal to 15 microns, less than or equal to 12 microns, less than or equal to 10 microns, less than or equal to 9 microns, less than or equal to 8 microns, less than or equal to 7 microns, less than or equal to 6 microns, or less than or equal to 5 microns. In some embodiments, a filter media has a micron rating for a beta 200 efficiency of greater than or equal to 2.5 microns, greater than or equal to 5 microns, greater than or equal to 6 microns, greater than or equal to 7 microns, greater than or equal to 8 microns, greater than or equal to 9 microns, greater than or equal to 10 microns, or greater than or equal to 12 microns. Combinations of the above-referenced ranges are also possible (e.g., less than or equal to 15 microns and greater than or equal to 2.5 microns, less than or equal to 10 microns and greater than or equal to 2.5 microns, or less than or equal to 5 microns and greater than or equal to 2.5 microns). Other ranges are also possible.

The micron rating for a beta 200 efficiency may be determined by performing a Multipass Filter Test following the ISO 16889 (2008) procedure (modified by testing a flat sheet sample) on a Multipass Filter Test Stand manufactured by FTI. The measurement may be made by flowing a test fluid comprising ISO A3 Medium test dust manufactured by PTI, Inc. at an upstream gravimetric dust level of 10 mg/liter in Aviation Hydraulic Fluid AERO HFA MIL H-5606A manufactured by Mobil through the filter media at a flow rate of 1.7 L/min until a terminal pressure drop of 172 kPa is reached.

In some embodiments, a filter media, such as a filter media suitable for hydraulic filtration, has a relatively high beta value at 5 microns at the midpoint of the Multipass Filter Test following the ISO 16889 (2008) procedure (modified by testing a flat sheet sample) on a Multipass Filter Test Stand manufactured by FTI described above. The beta value at 5 microns of a filter media at the midpoint of the Multipass Filter Test is the ratio of the upstream average particle count (C₀) to the downstream average particle count (C) for 5 micron particles at the point of the Multipass Filter Test when the pressure drop is 86 kPa (50% of the terminal value of 172 kPa). In some embodiments, a filter media has a beta value at 5 microns of a filter media at the midpoint of the Multipass Filter Test of greater than or equal to 100, greater than or equal to 125, greater than or equal to 150, greater than or equal to 175, greater than or equal to 200, greater than or equal to 225, greater than or equal to 250, greater than or equal to 275, greater than or equal to 300, or greater than or equal to 325. In some embodiments, a filter media has a beta value at 5 microns of a filter media at the midpoint of the Multipass Filter Test of less than or equal to 350, less than or equal to 325, less than or equal to 300, less than or equal to 275, less than or equal to 250, less than or equal to 225, less than or equal to 200, less than or equal to 175, less than or equal to 150, or less than or equal to 125. Combinations of the above-referenced ranges are also possible (e.g., greater than or equal to 100 and less than or equal to 350). Other ranges are also possible.

In some embodiments, a filter media, such as a filter media suitable for fuel filtration, has a relatively high average fuel-water separation efficiency. In some embodiments, a filter media has an average fuel-water separation efficiency of greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, or greater than or equal to 95%. In some embodiments, a filter media has an average fuel-water separation efficiency of less than or equal to 100%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, or less than or equal to 45%. Combinations of the above-referenced ranges are also possible (e.g., greater than or equal to 40% and less than or equal to 100%, greater than or equal to 50% and less than or equal to 100%, greater than or equal to 60% and less than or equal to 100%, or greater than or equal to 90% and less than or equal to 100%). Other ranges are also possible.

The average fuel-water separation efficiency of a filter media may be measured in accordance with the SAEJ1488 (2010) test. The test involves sending a sample of fuel (ultra-low sulfur diesel fuel) with controlled water content (2500 ppm) through a pump across the media at a face velocity of 0.069 cm/sec. The water is emulsified into fine droplets by a centrifugal pump operating at 3500 rpm, after which it is sent to challenge the media. The water is coalesced, shed, or both coalesced and shed, and collects at the bottom of the housing. The water content of the sample is measured via Karl Fischer titration both upstream and downstream of the media. The fuel-water separation efficiency is the amount of water removed from the fuel-water mixture and is equivalent to (1−C/2500)*100%, where C is the downstream concentration of water. The average efficiency is the average of the efficiencies measured during a 150 minute test. The first measurement of the sample upstream and downstream of the media is taken at 10 minutes from the start of the test. Then, measurement of the sample downstream of the media is taken every 20 minutes until 150 minutes have elapsed from the beginning of the test. The pressure of the sample upstream and downstream of the filter media is also measured at these points in time.

In some embodiments, a filter media, such as a filter media suitable for fuel filtration, exhibits a relatively low pressure drop during the SAEJ1488 (2010) test described above. For instance, in some embodiments, the maximum pressure drop measured for a filter media during the SAEJ1488 (2010) test is less than or equal to 150 mm H₂O, less than or equal to 140 mm H₂O, less than or equal to 130 mm H₂O, less than or equal to 120 mm H₂O, less than or equal to 110 mm H₂O, less than or equal to 100 mm H₂O, less than or equal to 90 mm H₂O, less than or equal to 80 mm H₂O, less than or equal to 70 mm H₂O, or less than or equal to 60 mm H₂O. In some embodiments, the maximum pressure drop measured for a filter media during the SAEJ1488 (2010) test is greater than or equal to 50 mm H₂O, greater than or equal to 60 mm H₂O, greater than or equal to 70 mm H₂O, greater than or equal to 80 mm H₂O, greater than or equal to 90 mm H₂O, greater than or equal to 100 mm H₂O, greater than or equal to 110 mm H₂O, greater than or equal to 120 mm H₂O, greater than or equal to 130 mm H₂O, or greater than or equal to 140 mm H₂O. Combinations of the above-referenced ranges are also possible (e.g., less than or equal to 150 mm H₂O and greater than or equal to 50 mm H₂O, or less than or equal to 100 mm H₂O and greater than or equal to 50 mm H₂O). Other ranges are also possible.

In some embodiments, a filter media described herein is capable of filtering contaminants from fuel for an appreciable period of time. In some embodiments, a filter media has an average lifetime of greater than or equal to 3 minutes, greater than or equal to 6 minutes, greater than or equal to 10 minutes, greater than or equal to 20 minutes, greater than or equal to 40 minutes, greater than or equal to 55 minutes, greater than or equal to 60 minutes, greater than or equal to 70 minutes, greater than or equal to 85 minutes, greater than or equal to 100 minutes, greater than or equal to 125 minutes, greater than or equal to 150 minutes, greater than or equal to 175 minutes, greater than or equal to 200 minutes, or greater than or equal to 225 minutes. In some embodiments, a filter media may has an average lifetime of less than or equal to 250 minutes, less than or equal to 225 minutes, less than or equal to 200 minutes, less than or equal to 175 minutes, less than or equal to 160 minutes, less than or equal to 130 minutes, less than or equal to 110 minutes, less than or equal to 85 minutes, less than or equal to 65 minutes, less than or equal to 50 minutes, or less than or equal to 25 minutes. Combinations of the above-referenced ranges are also possible (e.g., greater than or equal to 3 minutes and less than or equal to 200 minutes, greater than or equal to 6 minutes and less than or equal to 250 minutes). Other values of average lifetime are also possible. The lifetime may be determined by performing a flatsheet test according to the standard ISO 4020 (2001). The testing can be performed by flowing a test fluid through a 8 mm diameter filter media at a flow rate of the test fluid of 20 Lpm/m² and measuring the time, in minutes, required for the terminal pressure to reach 70 kPa. The test fluid employed can be mineral oil having a viscosity of 4-6 cST at 23° C. and comprising carbon black as an organic contaminant and Mira 2 aluminum oxide as an inorganic contaminant. The carbon black may be present in the mineral oil in an amount of 1.25 g/20 L of mineral oil. The Mira 2 aluminum oxide may be present in the mineral oil in an amount of 5 g/20 L of mineral oil.

The filter media described herein may have a relatively high initial water contact angle. For instance, a filter media may have an initial water contact angle of greater than or equal to 70°, greater than or equal to 80°, greater than or equal to 90°, greater than or equal to 100°, greater than or equal to 110°, greater than or equal to 120°, greater than or equal to 130°, greater than or equal to 140°, greater than or equal to 150°, greater than or equal to 160°, or greater than or equal to 170°. In some embodiments, a filter media has an initial water contact angle of less than or equal to 180°, less than or equal to 170°, less than or equal to 160°, less than or equal to 150°, less than or equal to 140°, less than or equal to 130°, less than or equal to 120°, less than or equal to 110°, less than or equal to 100°, less than or equal to 90°, or less than or equal to 80°. Combinations of the above-referenced ranges are also possible (e.g., greater than or equal to 70° and less than or equal to 180°, or greater than or equal to 90° and less than or equal to 180°). Other ranges are also possible. The initial water contact angle may be determined by following the procedure described in ASTM D5946 (2009) and measuring the contact angle within 15 seconds of water application.

The filter media described herein may have a variety of suitable basis weights. In some embodiments, a filter media has a basis weight of greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 450 gsm, or greater than or equal to 500 gsm. In some embodiments, a filter media has a basis weight of less than or equal to 550 gsm, less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 125 gsm, less than or equal to 100 gsm, less than or equal to 75 gsm, less than or equal to 50 gsm, less than or equal to 40 gsm, less than or equal to 30 gsm, less than or equal to 25 gsm, or less than or equal to 20 gsm. Combinations of the above-referenced ranges are also possible (e.g., greater than or equal to 15 gsm and less than or equal to 550 gsm, greater than or equal to 20 gsm and less than or equal to 350 gsm, or greater than or equal to 30 gsm and less than or equal to 250 gsm). Other ranges are also possible. The basis weight of a filter media may be determined in accordance with ISO 536:2012.

The filter media described herein may have a variety of suitable thicknesses. In some embodiments, a filter media has a thickness of greater than or equal to 0.2 mm, greater than or equal to 0.5 mm, greater than or equal to 0.75 mm, greater than or equal to 1 mm, greater than or equal to 1.25 mm, greater than or equal to 1.5 mm, or greater than or equal to 1.75 mm. In some embodiments, a filter media has a thickness of less than or equal to 2 mm, less than or equal to 1.75 mm, less than or equal to 1.5 mm, less than or equal to 1.25 mm, less than or equal to 1 mm, less than or equal to 0.75 mm, or less than or equal to 0.5 mm. Combinations of the above-referenced ranges are also possible (e.g., greater than or equal to 0.2 mm and less than or equal to 2 mm, or greater than or equal to 0.5 mm and less than or equal to 1 mm). Other ranges are also possible. The thickness of a filter media may be determined in accordance with BCIS-03A, Sept-09, Method 10 under 10 kPa applied pressure.

The filter media described herein may have a variety of suitable mean flow pore sizes. In some embodiments, a filter media has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, or greater than or equal to 15 microns. In some embodiments, a filter media has a mean flow pore size of less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 20 microns, greater than or equal to 0.1 micron and less than or equal to 15 microns, greater than or equal to 0.1 micron and less than or equal to 10 microns, or greater than or equal to 0.2 microns and less than or equal to 5 microns). Other ranges are also possible. The mean flow pore size of a filter media may be determined in accordance with ASTM F316 (2003).

The filter media described herein may have a variety of suitable maximum pore sizes. In some embodiments, a filter media has a maximum pore size of greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, or greater than or equal to 25 microns. In some embodiments, a filter media has a maximum pore size of less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, or less than or equal to 0.25 microns. Combinations of the above-referenced ranges are also possible (e.g., greater than or equal to 0.2 microns and less than or equal to 30 microns, greater than or equal to 0.2 microns and less than or equal to 20 microns, or greater than or equal to 0.3 microns and less than or equal to 15 microns). Other ranges are also possible. The maximum pore size of a filter media may be determined in accordance with ASTM F316 (2003).

The filter media described herein may have a variety of suitable ratios of maximum pore size to mean flow pore size. In some embodiments, a filter media has a ratio of maximum pore size to mean flow pore size of greater than or equal to 1.3, greater than or equal to 1.5, greater than or equal to 1.75, greater than or equal to 2, greater than or equal to 2.5, greater than or equal to 3, greater than or equal to 4, greater than or equal to 5, greater than or equal to 7.5, greater than or equal to 10, greater than or equal to 12.5, or greater than or equal to 15. In some embodiments, a filter media has a ratio of maximum pore size to mean flow pore size of less than or equal to 20, less than or equal to 15, less than or equal to 12.5, less than or equal to 10, less than or equal to 7.5, less than or equal to 5, less than or equal to 4, less than or equal to 3, less than or equal to 2.5, less than or equal to 2, less than or equal to 1.75, or less than or equal to 1.5. Combinations of the above-referenced ranges are also possible (e.g., greater than or equal to 1.3 and less than or equal to 30, greater than or equal to 1.3 and less than or equal to 25, or greater than or equal to 1.3 and less than or equal to 20). Other ranges are also possible. The ratio of maximum pore size to mean flow pore size of a filter media may be determined by finding the maximum pore size and mean flow pore size in accordance with ASTM F316 (2003) and then dividing the maximum pore size by the mean flow pore size.

The filter media described herein may have a variety of suitable air permeabilities. In some embodiments, the air permeability of the filter media may be comparable to and/or slightly less than the air permeability of the least permeable layer therein (e.g., a layer comprising nanofibers therein). In some embodiments, a filter media has an air permeability of 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, or greater than or equal to 75 CFM. In some embodiments, a filter media has an air permeability of less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 100 CFM, greater than or equal to 1 CFM and less than or equal to 150 CFM, or greater than or equal to 1 CFM and less than or equal to 50 CFM). Other ranges are also possible. The air permeability of a filter media may be determined in accordance with ASTM Test Standard D737-04 (2016) at a pressure of 125 Pa.

In some embodiments, a filter media described herein may be a component of a filter element. That is, the filter media may be incorporated into an article suitable for use by an end user. Non-limiting examples of suitable filter elements include flat panel filters, V-bank filters (comprising, e.g., between 1 and 24 Vs), cartridge filters, cylindrical filters, conical filters, and curvilinear filters. Filter elements may have any suitable height (e.g., between 2 inches and 124 inches for flat panel filters, between 4 inches and 124 inches for V-bank filters, between 1 inch and 124 inches for cartridge and cylindrical filter media). Filter elements may also have any suitable width (between 2 inches and 124 inches for flat panel filters, between 4 inches and 124 inches for V-bank filters). Some filter media (e.g., cartridge filter media, cylindrical filter media) may be characterized by a diameter instead of a width; these filter media may have a diameter of any suitable value (e.g., between 1 inch and 124 inches). Filter elements typically comprise a frame, which may be made of one or more materials such as cardboard, aluminum, steel, alloys, wood, and polymers.

In some embodiments, a filter media described herein may be a component of a filter element and may be pleated. The pleat height and pleat density (number of pleats per unit length of the media) may be selected as desired. In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ inch and 24 inches, and/or pleat densities between 1 and 50 pleats/inch. As another example, filter media within cartridge filters or conical filters may have pleat heights between ¼ inch and 24 inches and/or pleat densities between ½ and 100 pleats/inch. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

The filter media described herein may be suitable for filtering a variety of fluids. For instance, the filter media described herein may be liquid filters and/or air filters. The liquid may be water, fuel, or another fluid. For instance, the fluid may comprise diesel fuel, hydraulic fluid, oil and/or other hydrocarbon liquids. Some methods may comprise employing a filter media described herein to filter a fluid, such as to filter a liquid (e.g., water, fuel) or to filter air. The method may comprise passing a fluid (e.g., a fluid to be filtered) through the filter media. When the fluid is passed through the filter media, the components filtered from the fluid may be retained on an upstream side of the filter media and/or within the filter media. The filtrate may be passed through the filter media.

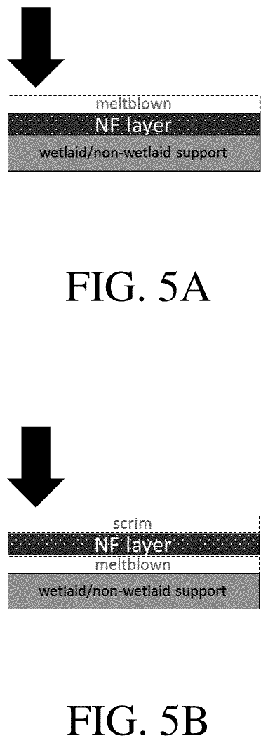

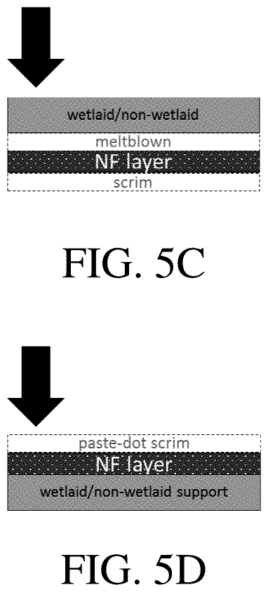

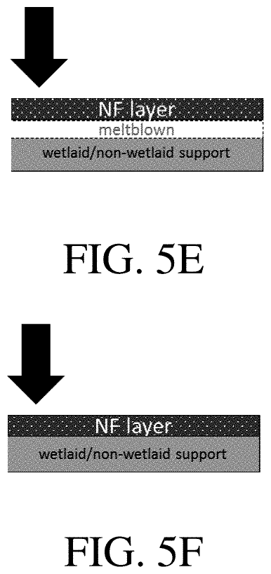

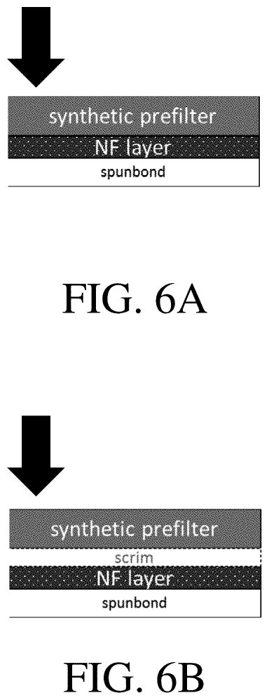

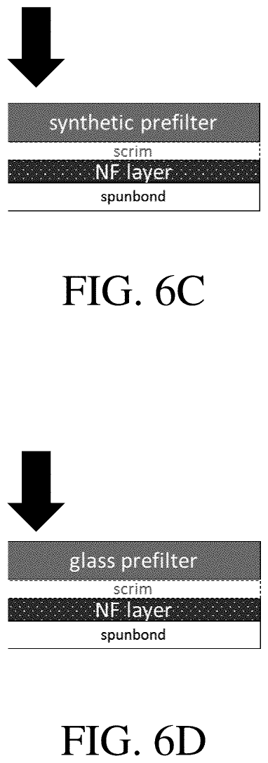

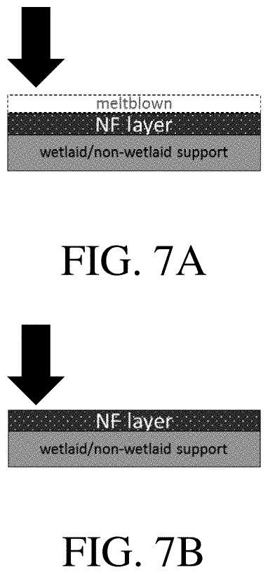

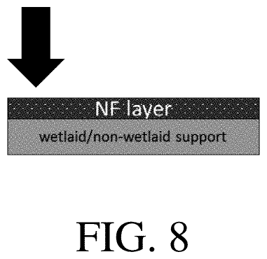

As described above, the filter media described herein may have a variety of suitable designs and a variety of suitable arrangements of the layers therein. Non-limiting examples of designs suitable for fuel filters are shown in FIGS. 5A-5F, non-limiting examples of designs suitable for hydraulic fluid filters are shown in FIGS. 6A-6D, non-limiting examples of designs suitable for HEPA filters are shown in FIGS. 7A-7B, and one non-limiting example of a design suitable for gas turbines and/or dust collectors is shown in FIG. 8. The arrows shown in FIGS. 5A-5F, 6A-6D, 7A-7B, and 8 indicate the direction in which the fuel would flow through the filter media. “NF layer” refers to a layer comprising nanofibers. Further properties of some exemplary layers that may be included in filter media are described below in Table 1, and further properties of some exemplary filter media including these layers are described below in Tables 2-5.

TABLE 1

| | | | Mean | | Mean | |
|---|---|---|---|---|---|---|
| | | Air | flow pore | Basis | fiber | |
| Type of | | permeability | size | weight | width | Elongation |
| layer | Fiber composition | (CFM) | (microns) | (gsm) | (microns) | at break |
| Layer | Multiblock | 0.5-10, 1-10, | 0.1-15, | 0.1-10, | 0.05-0.25 | 50%- |
| comprising | copolymer | 5-75, or 10- | 0.5-15, 1- | 0.1-3, | | 100% |
| nanofibers | comprising one or | 50 | 15, or 2- | or 0.1- | | |
| | more poly(amide) | | 15 | 5 | | |
| | blocks and one or | | | | | |
| | more poly(ether) | | | | | |
| | blocks, wherein | | | | | |
| | the poly(amide) | | | | | |
| | blocks make up | | | | | |
| | greater than or | | | | | |
| | equal to 20 mol % | | | | | |
| | of the multiblock | | | | | |
| | copolymer; may | | | | | |
| | further comprise | | | | | |
| | nanoparticles | | | | | |
| Meltblown | Nylon and/or | 0.5-10 or 5- | 0.1-15 or | 5-100 | 0.5-10 | 1%-50% |
| (may be | poly(butylene | 100 | 3-25 | or 10- | | |
| calendered) | terephthalate) | | | 100 | | |
| Wetlaid | Synthetic and/or | 20-200 | 15-100 | 50-200 | 1-30 | 1%-20% |
| layer or non- | cellulose | | | | | |
| wetlaid layer | | | | | | |
| (maybe | | | | | | |
| spunbond, | | | | | | |
| meltblown, | | | | | | |
| or carded) | | | | | | |
| Scrim (may | Poly(ester), Nylon, | 50-8000 | 30-200 | 5-50 | 1-30 | 1%-50% |
| be paste-dot, | and/or other | | | | | |
| may be | polymers | | | | | |
| spunbond or | | | | | | |
| meltblown) | | | | | | |
| Synthetic | Poly(ester), Nylon, | 5-100 | 3-25 | 5-100 | 0.5-30 | 1%-50% |
| prefilter | and/or other | | | | | |
| (may be | polymers | | | | | |
| wetlaid or | | | | | | |
| meltblown) | | | | | | |
| Glass | Glass | 5-100 | 3-25 | 5-100 | 0.5-30 | 1%-50% |
| prefilter | | | | | | |

TABLE 2

| | Arrangement of | | Initial | Dust | | Mean |
|---|---|---|---|---|---|---|
| | layers (from | Air | efficiency | holding | Fuel-water | flow pore |
| Design | upstream surface to | permeability | at 1.5 | capacity | separation | size |
| no. | downstream surface) | (CFM) | microns | (gsm) | efficiency | (microns) |
| 1 | 1-7 meltblown layers | 0.5-15 | 90%- | 50-300 | 80%- | 0.1-15 |
| (shown | (together having an | | 99.99% | | 100% | |
| in FIG. | air permeability of 5- | | | | | |
| 5A) | 100 CFM, a mean | | | | | |
| | flow pore size of 3- | | | | | |
| | 25 microns, a basis | | | | | |
| | weight of 5-100 gsm, | | | | | |
| | a mean fiber width | | | | | |
| | of 0.5-10 microns, | | | | | |
| | and an elongation at | | | | | |
| | break of 1%-50%) | | | | | |
| | Layer comprising | | | | | |
| | nanofibers (having | | | | | |
| | an air permeability | | | | | |
| | of 0.5-10 CFM, a | | | | | |
| | mean flow pore size | | | | | |
| | of 0.1-15 microns, a | | | | | |
| | basis weight of 0.1- | | | | | |
| | 10 gsm, a mean fiber | | | | | |
| | width of 0.05-0.25 | | | | | |
| | microns, and an | | | | | |
| | elongation at break | | | | | |
| | of 50%-100%) | | | | | |
| | Wetlaid or non- | | | | | |
| | wetlaid layer (having | | | | | |
| | an air permeability | | | | | |
| | of 20-200 CFM, a | | | | | |
| | mean flow pore size | | | | | |
| | of 15-100 microns, a | | | | | |
| | basis weight of 50- | | | | | |
| | 200 gsm, a mean | | | | | |
| | fiber width of 1-30 | | | | | |
| | microns, and an | | | | | |
| | elongation at break | | | | | |
| | of 1%-20%) | | | | | |
| 2 | Scrim (having an air | 0.5-15 | 90%- | 50-300 | 80%- | 0.1-15 |
| (shown | permeability of 50- | | 99.99% | | 100% | |
| in FIG. | 8000 CFM, a mean | | | | | |
| 5B) | flow pore size of 30- | | | | | |
| | 200 microns, a basis | | | | | |
| | weight of 5-50 gsm, | | | | | |
| | a mean fiber width | | | | | |
| | of 1-30 microns, and | | | | | |
| | an elongation at | | | | | |
| | break of 1%-50%) | | | | | |
| | Layer comprising | | | | | |
| | nanofibers (having | | | | | |
| | an air permeability | | | | | |
| | of 1-10 CFM, a | | | | | |
| | mean flow pore size | | | | | |
| | of 0.1-15 microns, a | | | | | |
| | basis weight of 0.1- | | | | | |
| | 10 gsm, a mean fiber | | | | | |
| | width of 0.05-0.25 | | | | | |
| | microns, and an | | | | | |
| | elongation at break | | | | | |
| | of 50%-100%) | | | | | |
| | Meltblown layer | | | | | |
| | (having an air | | | | | |
| | permeability of 0.5- | | | | | |
| | 100 CFM, a mean | | | | | |
| | flow pore size of | | | | | |
| | 0.1-15 microns, a | | | | | |
| | basis weight of 10- | | | | | |
| | 100 gsm, a mean | | | | | |
| | fiber width of 0.5-10 | | | | | |
| | microns, and an | | | | | |
| | elongation at break | | | | | |
| | of 1%-50%) | | | | | |
| | Wetlaid or non- | | | | | |
| | wetlaid layer (having | | | | | |
| | an air permeability | | | | | |
| | of 20-200 CFM, a | | | | | |
| | mean flow pore size | | | | | |
| | of 15-100 microns, a | | | | | |
| | basis weight of 50- | | | | | |
| | 200 gsm, a mean | | | | | |
| | fiber width of 1-30 | | | | | |
| | microns, and an | | | | | |
| | elongation at break | | | | | |
| | of 1%-20%) | | | | | |
| 3 | Wetlaid or non- | 0.5-15 | 90%- | 50-300 | 80%- | 0.1-15 |
| (shown | wetlaid layer (having | | 99.99% | | 100% | |
| in FIG. | an air permeability | | | | | |
| 5C) | of 20-200 CFM, a | | | | | |
| | mean flow pore size | | | | | |
| | of 15-100 microns, a | | | | | |
| | basis weight of 50- | | | | | |
| | 200 gsm, a mean | | | | | |
| | fiber width of 1-30 | | | | | |
| | microns, and an | | | | | |
| | elongation at break | | | | | |
| | of 1%-20%) | | | | | |
| | 1-7 meltblown layers | | | | | |
| | (together having an | | | | | |
| | air permeability of 5- | | | | | |
| | 100 CFM, a mean | | | | | |
| | flow pore size of 3- | | | | | |
| | 25 microns, a basis | | | | | |
| | weight of 5-100 gsm, | | | | | |
| | a mean fiber width | | | | | |
| | of 0.5-10 microns, | | | | | |
| | and an elongation at | | | | | |
| | break of 1%-50%) | | | | | |
| | Layer comprising | | | | | |
| | nanofibers (having | | | | | |
| | an air permeability | | | | | |
| | of 0.5-10 CFM, a | | | | | |
| | mean flow pore size | | | | | |
| | of 0.1-15 microns, a | | | | | |
| | basis weight of 0.1- | | | | | |
| | 10 gsm, a mean fiber | | | | | |
| | width of 0.05-0.25 | | | | | |
| | microns, and an | | | | | |
| | elongation at break | | | | | |
| | of 50%-100%) | | | | | |
| | Scrim (having an air | | | | | |
| | permeability of 50- | | | | | |
| | 8000 CFM, a mean | | | | | |
| | flow pore size of 30- | | | | | |
| | 200 microns, a basis | | | | | |
| | weight of 5-50 gsm, | | | | | |
| | a mean fiber width | | | | | |
| | of 1-30 microns, and | | | | | |
| | an elongation at | | | | | |
| | break of 1%-50%) | | | | | |
| 4 | Paste-dot scrim | 0.5-15 | 90%- | 50-300 | 80%- | 0.1-15 |
| (shown | (having an air | | 99.99% | | 100% | |
| in FIG. | permeability of 50- | | | | | |
| 5D) | 8000 CFM, a mean | | | | | |
| | flow pore size of 30- | | | | | |
| | 200 microns, a basis | | | | | |
| | weight of 5-50 gsm, | | | | | |
| | a mean fiber width | | | | | |
| | of 1-30 microns, and | | | | | |
| | an elongation at | | | | | |
| | break of 1%-50%) | | | | | |
| | Layer comprising | | | | | |
| | nanofibers (having | | | | | |
| | an air permeability | | | | | |
| | of 0.5-10 CFM, a | | | | | |
| | mean flow pore size | | | | | |
| | of 0.1-15 microns, a | | | | | |
| | basis weight of 0.1- | | | | | |
| | 10 gsm, a mean fiber | | | | | |
| | width of 0.05-0.25 | | | | | |
| | microns, and an | | | | | |
| | elongation at break | | | | | |
| | of 50%-100%) | | | | | |
| | Wetlaid or non- | | | | | |
| | wetlaid layer (having | | | | | |
| | an air permeability | | | | | |
| | of 20-200 CFM, a | | | | | |
| | mean flow pore size | | | | | |
| | of 15-100 microns, a | | | | | |
| | basis weight of 50- | | | | | |
| | 200 gsm, a mean | | | | | |
| | fiber width of 1-30 | | | | | |
| | microns, and an | | | | | |
| | elongation at break | | | | | |
| | of 1%-20%) | | | | | |
| 5 | Layer comprising | 0.5-15 | 90%- | 50-300 | 80%- | 0.1-15 |
| (shown | nanofibers (having | | 99.99% | | 100% | |
| in FIG. | an air permeability | | | | | |
| 5E) | of 1-10 CFM, a | | | | | |
| | mean flow pore size | | | | | |
| | of 1-15 microns, a | | | | | |
| | basis weight of 0.1- | | | | | |
| | 10 gsm, a mean fiber | | | | | |
| | width of 0.05-0.25 | | | | | |
| | microns, and an | | | | | |
| | elongation at break | | | | | |
| | of 50%-100%) | | | | | |
| | Meltblown layer | | | | | |
| | (having an air | | | | | |
| | permeability of 0.5- | | | | | |
| | 10 CFM, a mean | | | | | |
| | flow pore size of | | | | | |
| | 0.1-15 microns, a | | | | | |
| | basis weight of 10- | | | | | |
| | 100 gsm, a mean | | | | | |
| | fiber width of 0.5-10 | | | | | |
| | microns, and an | | | | | |
| | elongation at break | | | | | |
| | of 1%-50%) | | | | | |
| | Wetlaid or non- | | | | | |
| | wetlaid layer (having | | | | | |
| | an air permeability | | | | | |
| | of 20-200 CFM, a | | | | | |
| | mean flow pore size | | | | | |
| | of 15-100 microns, a | | | | | |
| | basis weight of 50- | | | | | |
| | 200 gsm, a mean | | | | | |
| | fiber width of 1-30 | | | | | |
| | microns, and an | | | | | |
| | elongation at break | | | | | |
| | of 1%-20%) | | | | | |
| 6 | Layer comprising | 0.5-15 | 90%- | 50-300 | 80%- | 0.1-15 |
| (shown | nanofibers (having | | 99.99% | | 100% | |
| in FIG. | an air permeability | | | | | |
| 5F) | of 1-10 CFM, a | | | | | |
| | mean flow pore size | | | | | |
| | of 1-15 microns, a | | | | | |
| | basis weight of 0.1- | | | | | |
| | 10 gsm, a mean fiber | | | | | |
| | width of 0.05-0.25 | | | | | |
| | microns, and an | | | | | |
| | elongation at break | | | | | |
| | of 50%-100%) | | | | | |
| | Wetlaid or non- | | | | | |
| | wetlaid layer (having | | | | | |
| | an air permeability | | | | | |
| | of 20-200 CFM, a | | | | | |
| | mean flow pore size | | | | | |
| | of 15-100 microns, a | | | | | |
| | basis weight of 50- | | | | | |
| | 200 gsm, a mean | | | | | |
| | fiber width of 1-30 | | | | | |
| | microns, and an | | | | | |
| | elongation at break | | | | | |
| | of 1%-20%) | | | | | |

TABLE 3

| | | | | | | Able to |
|---|---|---|---|---|---|---|
| | | | | | | withstand |
| | | | | | | Multipass |
| | | | | | | Filter Test |
| | | | | | | following |
| | | | | | | the ISO |
| | | | | | | 16889 |
| | | | | | | (2008) |
| | Arrangement of | | Micron | | | procedure |
| | layers (from | | rating for | Dust | Mean | (modified by |
| | upstream surface | Air | beta 200 | holding | flow pore | testing a flat |
| Design | to downstream | permeability | efficiency | capacity | size | sheet |
| no. | surface) | (CFM) | (microns) | (gsm) | (microns) | sample)? |
| 7 | 1-7 synthetic | 10-50 | 2-15 | 100-300 | 0.5-15 | Yes |
| (shown | prefilters (together | | | | | |
| in FIG. | having an air | | | | | |
| 6A) | permeability of 5- | | | | | |
| | 100 CFM, a mean | | | | | |
| | flow pore size of | | | | | |
| | 3-25 microns, a | | | | | |
| | basis weight of 5- | | | | | |
| | 100 gsm, a mean | | | | | |
| | fiber width of 0.5- | | | | | |
| | 30 microns, and an | | | | | |
| | elongation at break | | | | | |
| | of 1%-50%) | | | | | |
| | Layer comprising | | | | | |
| | nanofibers (having | | | | | |
| | an air permeability | | | | | |
| | of 5-75 CFM, a | | | | | |
| | mean flow pore | | | | | |
| | size of 0.5-15 | | | | | |
| | microns, a basis | | | | | |
| | weight of 0.1-3 | | | | | |
| | gsm, a mean fiber | | | | | |
| | width of 0.05-0.25 | | | | | |
| | microns, and an | | | | | |
| | elongation at break | | | | | |
| | of 50%-100%) | | | | | |
| | Scrim (having an | | | | | |
| | air permeability of | | | | | |
| | 50-8000 CFM, a | | | | | |
| | mean flow pore | | | | | |
| | size of 30-200 | | | | | |
| | microns, a basis | | | | | |
| | weight of 5-50 | | | | | |
| | gsm, a mean fiber | | | | | |
| | width of 1-30 | | | | | |
| | microns, and an | | | | | |
| | elongation at break | | | | | |
| | of 1%-50%) | | | | | |
| 8 | 1-7 synthetic | 10-50 | 2-12 | 100-300 | 0.5-15 | Yes |
| (shown | prefilters (together | | | | | |
| in FIG. | having an air | | | | | |
| 6B) | permeability of 5- | | | | | |
| | 100 CFM, a mean | | | | | |
| | flow pore size of | | | | | |
| | 3-25 microns, a | | | | | |
| | basis weight of 5- | | | | | |
| | 100 gsm, a mean | | | | | |
| | fiber width of 0.5- | | | | | |
| | 30 microns, and an | | | | | |
| | elongation at break | | | | | |
| | of 1%-50%) | | | | | |
| | Scrim (having an | | | | | |
| | air permeability of | | | | | |
| | 50-8000 CFM, a | | | | | |
| | mean flow pore | | | | | |
| | size of 30-200 | | | | | |
| | microns, a basis | | | | | |
| | weight of 5-50 | | | | | |
| | gsm, a mean fiber | | | | | |
| | width of 1-30 | | | | | |
| | microns, and an | | | | | |
| | elongation at break | | | | | |
| | of 1%-50%) | | | | | |
| | Layer comprising | | | | | |
| | nanofibers (having | | | | | |
| | an air permeability | | | | | |
| | of 5-75 CFM, a | | | | | |
| | mean flow pore | | | | | |
| | size of 0.5-15 | | | | | |
| | microns, a basis | | | | | |
| | weight of 0.1-3 | | | | | |
| | gsm, a mean fiber | | | | | |
| | width of 0.05-0.25 | | | | | |
| | microns, and an | | | | | |
| | elongation at break | | | | | |
| | of 50%-100%) | | | | | |
| | Scrim (having an | | | | | |
| | air permeability of | | | | | |
| | 50-8000 CFM, a | | | | | |
| | mean flow pore | | | | | |
| | size of 30-200 | | | | | |
| | microns, a basis | | | | | |
| | weight of 5-50 | | | | | |
| | gsm, a mean fiber | | | | | |
| | width of 1-30 | | | | | |
| | microns, and an | | | | | |
| | elongation at break | | | | | |
| | of 1%-50%) | | | | | |
| 9 | 1-7 glass prefilters | 10-50 | 2-12 | 100-300 | 0.5-15 | Yes |
| (shown | (together having an | | | | | |
| in FIG. | air permeability of | | | | | |
| 6C) | 5-100 CFM, a | | | | | |
| | mean flow pore | | | | | |
| | size of 3-25 | | | | | |
| | microns, a basis | | | | | |
| | weight of 5-100 | | | | | |
| | gsm, a mean fiber | | | | | |
| | width of 0.5-30 | | | | | |
| | microns, and an | | | | | |
| | elongation at break | | | | | |
| | of 1%-50%) | | | | | |
| | 1-7 meltblown | | | | | |
| | layers (together | | | | | |
| | having an air | | | | | |
| | permeability of 5- | | | | | |
| | 100 CFM, a mean | | | | | |
| | flow pore size of | | | | | |
| | 3-25 microns, a | | | | | |
| | basis weight of 5- | | | | | |
| | 100 gsm, a mean | | | | | |
| | fiber width of 0.5- | | | | | |
| | 10 microns, and an | | | | | |
| | elongation at break | | | | | |
| | of 1%-50%) | | | | | |
| | Layer comprising | | | | | |
| | nanofibers (having | | | | | |
| | an air permeability | | | | | |
| | of 0.5-10 CFM, a | | | | | |
| | mean flow pore | | | | | |
| | size of 0.1-15 | | | | | |
| | microns, a basis | | | | | |
| | weight of 0.1-3 | | | | | |
| | gsm, a mean fiber | | | | | |
| | width of 0.05-0.25 | | | | | |
| | microns, and an | | | | | |
| | elongation at break | | | | | |
| | of 50%-100%) | | | | | |
| | Scrim (having an | | | | | |
| | air permeability of | | | | | |
| | 50-8000 CFM, a | | | | | |
| | mean flow pore | | | | | |
| | size of 30-200 | | | | | |
| | microns, a basis | | | | | |
| | weight of 5-50 | | | | | |
| | gsm, a mean fiber | | | | | |
| | width of 1-30 | | | | | |
| | microns, and an | | | | | |
| | elongation at break | | | | | |
| | of 1%-50%) | | | | | |
| 10 | 1-7 glass prefilters | 10-50 | 2-12 | 100-300 | 0.5-15 | Yes |
| (shown | (together having an | | | | | |
| in FIG. | air permeability of | | | | | |
| 6D) | 5-100 CFM, a | | | | | |
| | mean flow pore | | | | | |
| | size of 3-25 | | | | | |
| | microns, a basis | | | | | |
| | weight of 5-100 | | | | | |
| | gsm, a mean fiber | | | | | |
| | width of 0.5-30 | | | | | |
| | microns, and an | | | | | |
| | elongation at break | | | | | |
| | of 1%-50%) | | | | | |
| | Scrim (having an | | | | | |
| | air permeability of | | | | | |
| | 50-8000 CFM, a | | | | | |
| | mean flow pore | | | | | |
| | size of 30-200 | | | | | |
| | microns, a basis | | | | | |
| | weight of 5-50 | | | | | |
| | gsm, a mean fiber | | | | | |
| | width of 1-30 | | | | | |
| | microns, and an | | | | | |
| | elongation at break | | | | | |
| | of 1%-50%) | | | | | |
| | Layer comprising | | | | | |
| | nanofibers (having | | | | | |
| | an air permeability | | | | | |
| | of 0.5-10 CFM, a | | | | | |
| | mean flow pore | | | | | |
| | size of 0.1-15 | | | | | |
| | microns, a basis | | | | | |
| | weight of 0.1-3 | | | | | |
| | gsm, a mean fiber | | | | | |
| | width of 0.05-0.25 | | | | | |
| | microns, and an | | | | | |
| | elongation at break | | | | | |
| | of 50%-100%) | | | | | |
| | Scrim (having an | | | | | |
| | air permeability of | | | | | |
| | 50-8000 CFM, a | | | | | |
| | mean flow pore | | | | | |
| | size of 30-200 | | | | | |
| | microns, a basis | | | | | |
| | weight of 5-50 | | | | | |
| | gsm, a mean fiber | | | | | |
| | width of 1-30 | | | | | |
| | microns, and an | | | | | |
| | elongation at break | | | | | |
| | of 1%-50%) | | | | | |

TABLE 4

| | Arrangement of layers | Air | | | Mean flow |
|---|---|---|---|---|---|
| Design | (from upstream surface | permeability | MPPS | MPPS | pore size |
| no. | to downstream surface) | (CFM) | penetration | gamma | (microns) |
| 11 | Meltblown layer (having an air | 0.5-15 | 0.01%-1% | 30-70 | 0.1-15 |
| (shown in | permeability of 5-100 CFM, a | | | | |
| FIG. 7A) | mean flow pore size of 3-25 | | | | |
| | microns, a basis weight of 5- | | | | |
| | 100 gsm, a mean fiber width of | | | | |
| | 0.5-10 microns, and an | | | | |
| | elongation at break of 1%-50%) | | | | |
| | Layer comprising nanofibers | | | | |
| | (having an air permeability of | | | | |
| | 0.5-10 CFM, a mean flow pore | | | | |
| | size 0.1-15 microns, a basis | | | | |
| | weight of 0.1-10 gsm, a mean | | | | |
| | fiber width of 0.05-0.25 | | | | |
| | microns, and an elongation at | | | | |
| | break of 50%-100%) | | | | |
| | Wetlaid or non-wetlaid layer | | | | |
| | (having an air permeability of | | | | |
| | 20-200 CFM a mean flow pore | | | | |
| | size of 15-100 microns, a basis | | | | |
| | weight of 50-200 gsm, a mean | | | | |
| | fiber wideth of 1-30 microns, | | | | |
| | and an elongation at break of | | | | |
| | 1%-20%) | | | | |
| 12 | Layer comprising nanofibers | 0.5-15 | 0.01%-0.1% | 30-70 | 0.1-15 |
| (shown in | (having an air permeadability of | | | | |
| FIG. 7B.) | 0.5-10 CFM, a mean flow pore | | | | |
| | size of 0.1-15 microns, and a | | | | |
| | basis weight of 0.1-10 gms, a | | | | |
| | mean fiber width of 0.05-0.25 | | | | |
| | microns, and an elongation at | | | | |
| | break of 50%-100%) | | | | |
| | Wetlaid or non-wetlaid layer | | | | |
| | (having an air permeability of | | | | |
| | 20-200 CFM, a mean flow pore | | | | |
| | size of 15-100 microns, a basis | | | | |
| | weight of 50-200 gsm, a mean | | | | |
| | fiber width of 1-30 microns, | | | | |
| | and an elongation at break of | | | | |
| | 1%-20%) | | | | |

TABLE 5

| | Arrangement of layers | | Penetration | |
|---|---|---|---|---|
| Design | (from upstream surface | Air permeability | for 0.2 micron | |
| no. | to downstream surface) | (CFM) | particles | Air resistance (mm H₂O) |
| 13 | Layer comprising | 10-50 | 1%-60% or 1%-40% | 0.5-15 or 0.5-10 |
| (shown in | nanofibers (having an | | | |
| FIG. 8) | air permeability of | | | |
| | 10-50 CFM, a mean flow | | | |
| | pore size of 2-15 microns, | | | |
| | a basis weight of 0.1-5 gsm, | | | |
| | a mean fiber width of | | | |
| | 0.05-0.25 microns, | | | |
| | and an elongation | | | |
| | at break of 50%-100%) | | | |
| | Wetlaid or non-wetlaid | | | |
| | layer (having an air | | | |
| | permeability of 20-200 | | | |
| | CFM, a mean flow pore | | | |
| | size of 15-100 microns, | | | |
| | a basis weight of | | | |
| | 50-200 gsm, a mean fiber | | | |
| | width of 1-30 microns, | | | |
| | and an elongation at | | | |
| | break of 1%-20%) | | | |

### Example 1

This Example describes the fabrication and testing of filter media comprising a layer comprising nanofibers and a wetlaid backer layer. The nanofibers comprised a multiblock copolymer that is an elastomer.

Each filter media was formed by electrospinning a fluid comprising a multiblock copolymer onto a wetlaid backer layer to form a layer comprising nanofibers comprising the multiblock copolymer disposed on the wetlaid backer layer. A control filter media was also formed by this same process, except that the fluid that was electrospun and the resulting nanofibers comprised Nylon 6 instead of a multiblock copolymer. The composition of each multiblock copolymer employed to form a layer comprising nanofibers is shown below in Table 6.

After filter media formation, a variety of properties of each filter media and the layer comprising the nanofibers therein were measured by techniques described elsewhere herein. These properties are summarized in Table 7.

As shown in Table 7, the layers comprising nanofibers in Filter Media 1 and 2 had larger mean fiber widths than the layer comprising nanofibers in Control Filter Media 1. It is believed that this is due to the presence of ribbon-shaped fibers in these layers, which have a comparatively larger width than cylindrical fibers having an equivalent cross-sectional area, and the lack of ribbon-shaped fibers in the layer comprising nanofibers in Control Filter Media 1.

As also shown in Table 7, all of the filter media had a high filtration efficiency and similar air permeability, but the high hydrophilicity of Control Filter Media 1 caused it to display a much higher maximum pressure drop during fuel-water separation efficiency testing than the comparatively hydrophobic Filter Media 1-3. It is believed that this is due to the relatively higher hydrophilicity of the Nylon 6 present in the nanofibers of Control Filter Media 1 in comparison to the multiblock copolymers present in Filter Media 1-3.

TABLE 6

| Filter | Filter | Filter | Filter | Control Filter |
|---|---|---|---|---|
| Media No. | Media 1 | Media 2 | Media 3 | Media 1 |
| Polymer in layer | Multiblock 1 | Multiblock 2 | Multiblock 3 | Nylon 6 |
| comprising | (multiblock copolymer | (multiblock copolymer | (multiblock copolymer | |
| nanofibers | comprising 20 mol | comprising 20 mol % | comprising poly(amide) | |
| | % poly(amide) | poly(amide) blocks and | blocks and non-poly(amide) | |
| | blocks and 80 mol % | 80 mol % non-poly(amide) | blocks) | |
| | non-poly(amide) | blocks) | | |
| | blocks) | | | |

TABLE 7

| Filter | Filter | Filter | Filter | Control Filter |
|---|---|---|---|---|
| Media No. | Media 1 | Media 2 | Media 3 | Media 1 |
| Air permeability | 4.0 ± 0.7 | 5.0 ± 0.8 | 4.7 | 4.7 ± 0.4 |
| (CFM) | | | | |
| Mean fiber width of | 232 | 138 | | 103 |
| layer comprising the | | | | |
| nanofibers (microns) | | | | |
| Mean flow pore size | 0.86 ± 0.24 | 0.6 ± 0.1 | | 0.39 ± 0.01 |
| (microns) | | | | |
| Initial water contact | 94 ± 2 | 106 ± 3 | | 46 ± 4 |
| angle (°) | | | | |
| Initial efficiency | 99.90% | 99.85% | 99.82% | 99.92 ± 0.03% |
| at 4 microns | | | | |
| Initial efficiency | 97.87 ± 1.6% | 99.24% | 99.85% | 97.5 ± 2.2% |
| at 1.5 microns | | | | |
| Fuel-water separation | 95.4% | 96.7% | 91.0% | 93.0% |
| efficiency | | | | |
| Maximum pressure drop | 60 | 40 | 120 | >200 |
| during fuel-water | | | | |
| separation efficiency | | | | |
| measurement (mm H₂O) | | | | |

### Example 2

This Example describes the fabrication and testing of a filter media comprising a layer comprising nanofibers, a wetlaid backer layer, and a meltblown layer. The nanofibers comprised a multiblock copolymer that is an elastomer, the wetlaid backer layer comprised fibers comprising cellulose, and the meltblown layer comprised fibers comprising poly(butylene terephthalate).

The filter media was formed by the procedure described below. First, an acrylic adhesive was sprayed onto the wetlaid backer layer and onto the scrim to form coatings thereon having a basis weight of approximately 0.2 gsm. Then, the layer comprising the nanofibers was formed by electrospinning a fluid comprising Multiblock 2 (as described in Example 1) onto the adhesive disposed on the wetlaid backer layer. Finally, the scrim was positioned such that the adhesive was directly adjacent to the layer comprising the nanofibers and was laminated onto that layer.

A variety of properties of the filter media were measured by techniques described elsewhere herein. These properties are summarized in Table 8.

TABLE 8

| | |
|---|---|
| Air permeability (CFM) | 3.8 ± 0.5 |
| Initial efficiency | 99.5 ± 0.2% |
| at 1.5 microns | |
| Specific dust holding | 161 ± 20 |
| capacity (gsm/mm) | |
| Fuel-water separation | 95.7 ± 1.0% |
| efficiency | |

### Example 3

This Example describes the fabrication and testing of a filter media comprising a layer comprising nanofibers, a wetlaid backer layer, and a scrim. The nanofibers comprised a multiblock copolymer that is an elastomer, the wetlaid backer layer comprised synthetic fibers, and the scrim was a meltblown layer.

A procedure identical to that described in Example 2 was employed to form the filter media, except that the wetlaid backer layer comprised synthetic fibers instead of fibers comprising cellulose. This same procedure was also used to form a control filter media, except that: (1) the fluid that was electrospun to form the layer comprising nanofibers and the resulting nanofibers comprised Nylon 6 instead of a multiblock copolymer; and (2) the wetlaid backer layer comprised synthetic fibers instead of fibers comprising cellulose.

The overall micron rating for a beta 200 efficiency of each filter media and the beta value for 5 micron particles at the midpoint of the micron rating testing procedure were assessed as described elsewhere herein for both filter media. Table 9, below, summarizes the results. As can be seen from Table 10, the filter media including the layer comprising nanofibers comprising the multiblock copolymer had a lower micron rating for a beta 200 efficiency and a higher beta value at the midpoint of the micron rating testing procedure than the control filter media. These results evidence the failure of the control filter media during the test, which caused a large, early drop in performance during the test.

TABLE 9

| Sample | Filter | Control Filter |
|---|---|---|
| No. | Media 4 | Media 2 |
| Polymer in layer | Multiblock 2 | Nylon 6 |
| including | (as described | |
| nanofibers | in Example 1) | |
| Overall micron | 5.2 | 20 |
| rating for a beta 200 | | |
| efficiency of the | | |
| filter media | | |
| (microns) | | |
| Beta value for 5 | 258 | 3 |
| micron particles at | | |
| midpoint of micron | | |
| rating testing | | |
| procedure | | |

### Example 4

This Example describes the fabrication and testing of a free-standing layer comprising nanofibers comprising an elastomer.

The free-standing layer was formed by electrospinning a fluid comprising the elastomer onto wax paper at constant humidity and electric field. The resultant free-standing layer had a basis weight of approximately 5 gsm. Two control free-standing layers were also formed by this same process, except that the fluid that was electrospun and the resulting nanofibers comprised materials other than elastomers.

After electrospinning, each free-standing layer was removed from the wax paper and cut to form a 1″ by 7″ sample, which was loaded into a Thwing-Albert tensile tester equipped with a 20 N load cell. This tensile tester was employed to measure the percent elongation at break and specific tensile strength of each free-standing layer as described elsewhere herein. Table 10, below, summarizes the relevant properties of each free-standing layer.

As shown in Table 10, the free-standing layer comprising Multiblock 1 had a larger percent elongation at break than the control free-standing layers and had a similar specific tensile strength to the two control free-standing layers.

TABLE 10

| | | Control | Control |
|---|---|---|---|
| Free-Standing | Free-Standing | Free-Standing | Free-Standing |
| Layer No. | Layer 1 | Layer 1 | Layer 2 |
| Polymer in | Multiblock 1 | Nylon 6 | Poly(caprolactone) |
| free-standing | (as described | | |
| layer | in Example 1) | | |
| Percent | 80% | 35% | 55% |
| elongation | | | |
| at break | | | |
| Specific | 80 | 80 | 97 |
| tensile strength | | | |
| (g_{f}/gsm) | | | |
| Modulus | 91 ± 10 | 216 ± 14 | 174 |
| (g_{f}/gsm) | | | |

### Example 5

This Example describes the characterization of the fibrillation of layers comprising nanofibers. In each layer, the nanofibers comprise a multiblock copolymer that is an elastomer.

Each layer comprising nanofibers was formed by electrospinning a fluid comprising a multiblock copolymer onto a wetlaid backer layer to form a layer comprising nanofibers comprising the multiblock copolymer disposed on the wetlaid backer layer. A control filter media was also formed by this same process, except that the fluid that was electrospun and the resulting nanofibers comprised Nylon 6 instead of a multiblock copolymer. The composition of each multiblock copolymer employed to form a layer comprising nanofibers is shown below in Table 11.

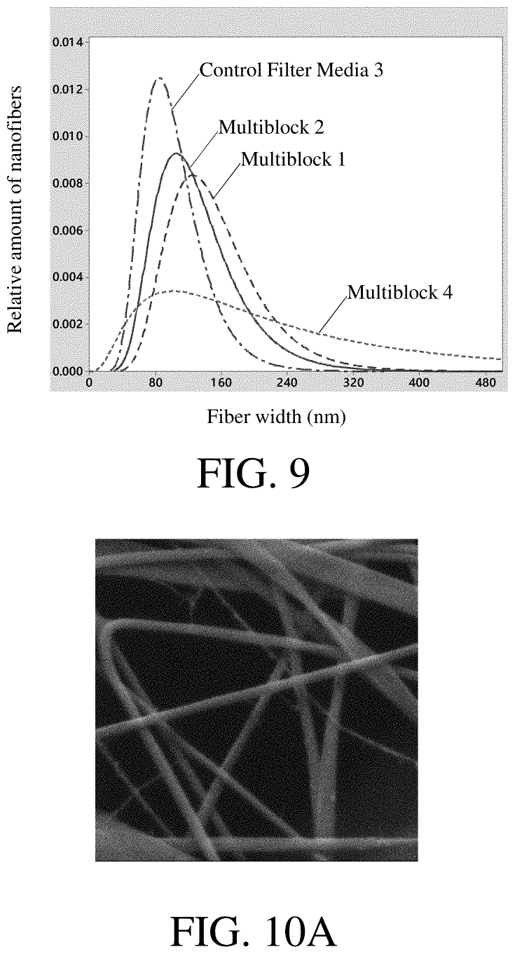

The width of the fibers in each layer comprising nanofibers was measured by techniques described elsewhere herein. Table 12 shows the mean fiber width and fiber width standard deviation for the nanofibers in each of these layers and FIG. 9 shows the distribution of fiber widths for each layer.

As can be seen from Table 12 and FIG. 9, the nanofibers comprising the multiblock copolymers had a larger fiber width than the nanofibers comprising Nylon 6, indicating the presence of larger amounts of ribbon-like fibers.

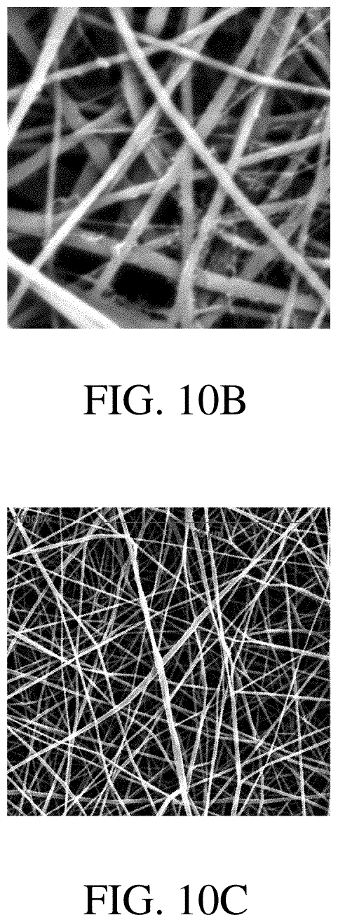

As can also be seen from Table 12, the nanofibers comprising the multiblock copolymers had a larger standard deviation in the nanofiber width than the nanofibers comprising Nylon 6, indicating a higher degree of fibrillation. FIGS. 10A, 10B, and 10C show SEM images of the layers comprising the nanofibers in Filter Media 6, Filter Media 7, and Control Filter Media 3, respectively. These images further evidence the presence of fibrillated fibers in Filter Medias 6 and 7, the lack of fibrillated fibers in Control Filter Media 3, and the enhanced fibrillation of the fibrillated fibers in Filter Media 7 in comparison to Filter Media 6.

TABLE 11

| Filter | Filter | Filter | Filter | Control Filter |
|---|---|---|---|---|
| Media No. | Media 5 | Media 6 | Media 7 | Media 3 |
| Polymer in | Multiblock 2 | Multiblock 1 | Multiblock 4 | Nylon 6 |
| layer | (as described | (as described | (multiblock copolymer | |
| including | in Example 1) | in Example 1) | comprising 30 mol % | |
| nanofibers | | | poly(amide) blocks | |
| | | | and 70 mol % | |
| | | | non-poly(amide) blocks) | |

TABLE 12

| Filter | Filter | Filter | Filter | Control Filter |
|---|---|---|---|---|
| Media No. | Media 5 | Media 6 | Media 7 | Media 3 |
| Mean fiber | 131 | 152 | 280 | 102 |
| width | | | | |
| (microns) | | | | |
| Fiber width | 53 | 56 | 284 | 32 |
| standard | | | | |
| deviation | | | | |
| (microns) | | | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a first layer comprising nanofibers, wherein the nanofibers comprise a multiblock copolymer comprising one or more poly(amide) blocks, and wherein the one or more poly(amide) blocks make up greater than or equal to 20 mol % and less than 100 mol % the multiblock copolymer; and
a second layer.

2. A filter media, comprising:
a first layer comprising nanofibers, wherein the nanofibers comprise an elastomer, and wherein the nanofibers are at least partially fibrillated; and
a second layer.

3. A filter media, comprising:
a first layer comprising nanofibers, wherein the nanofibers comprise an elastomer, and wherein the first layer has an initial water contact angle of greater than or equal to 70°; and
a second layer.

4. A filter media as in claim 1, wherein the first layer is a non-woven fiber web.

5. A filter media as in claim 1, wherein the second layer is a non-woven fiber web.

6-28. (canceled)

29. A filter media as in 1, wherein the poly(amide) blocks are semicrystalline.

30. A filter media as in claim 1, wherein the poly(amide) blocks have a melting point of greater than or equal to 100° C.

31. A filter media as in claim 1, wherein the multiblock copolymer comprises a block having a glass transition temperature of less than or equal to 20° C.

32. A filter media as in claim 1, wherein the multiblock copolymer comprises a block that is amorphous.

33-36. (canceled)

37. A filter media as in claim 1, wherein the multiblock copolymer comprises at least one poly(ether) block.

38-42. (canceled)

43. A filter media as in claim 1, wherein the at least one poly(amide) block comprises Nylon 11 and/or Nylon 12.

44. A filter media as in claim 37, wherein the at least one poly(ether) block comprises poly(tetrahydrofuran).

45-59. (canceled)

60. A filter media as in claim 1, wherein the first layer has a specific tensile strength of greater than or equal to 30 g/gsm.

61. A filter media as in claim 1, wherein the first layer has a water contact angle of greater than or equal to 70°.

62. A filter media as in claim 1, wherein the first layer has a mean flow pore size of greater than or equal to 0.1 micron and less than or equal to 15 microns.

63. A filter media as in claim 1, wherein the first layer has an air permeability of greater than or equal to 0.5 CFM and less than or equal to 10 CFM.

64-65. (canceled)

66. A filter media as in claim 1, wherein the nanofibers have a mean fiber width of greater than or equal to 75 nm and less than or equal to 750 nm.

67-72. (canceled)

73. A filter media as in claim 1, wherein the filter media has a gamma at the MPPS of greater than or equal to 30.

74-75. (canceled)

76. A filter media as in claim 1, wherein an adhesive is positioned between at least two of the layers.

77-83. (canceled)

84. A filter media as in claim 1, wherein the first layer is an electrospun layer.

85-101. (canceled)
